(19) United States
(12) Patent Application Publication
(10) Pub. No.: US 2026/0304504 A1
(43) Pub. Date: Oct. 1, 2026

(54) SEAMLESS WIRELESS CONNECTION ACROSS MULTIPLE USERS AND VEHICLES

(71) Applicant: Zoox, Inc., Foster City, CA (US)

(72) Inventors: Andrew Allen Haskin, San Francisco, CA (US); Justin Khoi-Nam Duc Nguyen, San Francisco, CA (US); Christopher James Pierick, Belmont, CA (US); Deniz Tumer, Oakland, CA (US); Alex Nicholas Wolowiecki, San Francisco, CA (US); Joshua Yao, San Francisco, CA (US)

(21) Appl. No.: 19/095,696

(22) Filed: Mar. 31, 2025

(51) Int. Cl. H04W 76/10; H04W 12/047; H04W 36/08

(52) U.S. Cl. CPC H04W 76/10; H04W 12/047; H04W 36/08

(57) ABSTRACT

Techniques for configuring a wireless connection between a user device and a vehicle are discussed herein. For example, techniques may include seamlessly pairing (for a first-time user) or connecting (for a repeat user) a user device with a vehicle configured to transport a user associated with the user device to their destination. A vehicle may receive a service request associated with a user device and/or an identifier for configuring a wireless connection (e.g., Bluetooth). The vehicle may determine a satisfaction of an initiation threshold (e.g., the vehicle is within a proximity of the user device), which may prompt the vehicle to configure the wireless connection of the vehicle such that the vehicle is communicatively coupled to the vehicle. The wireless connection may allow the vehicle to present configuration data (e.g., audio or heating preferences) in the vehicle, and may allow the user to modify the configuration data for their ride.

### BACKGROUND

Autonomous and semi-autonomous vehicles may transport riders from a starting location to a destination location. While in transit, a vehicle may be configured to interface with a rider's mobile device. Conventional techniques associated with a vehicle interfacing with a rider's mobile device may be inefficient, unintuitive, cumbersome, and/or may cause and/or leave behind residual data.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example environment configured to implement the examples of this disclosure.

FIGS. 2A and 2B illustrate an example process in accordance one or more of the techniques discussed herein.

FIG. 3 illustrates an example framework associated with pairing a first-time user and configured to implement one or more of the techniques discussed herein.

FIG. 4 illustrates an example framework associated with pairing a repeat user and configured to implement one or more of the techniques discussed herein.

FIG. 5 illustrates an example system in accordance with the techniques described herein.

FIG. 6 illustrates an example process in accordance with one or more of the techniques discussed herein.

### DETAILED DESCRIPTION

This application relates to improved techniques for wirelessly connecting user device(s) associated with a user to vehicle(s). More specifically, this application relates to more efficient, intuitive, and streamlined techniques for communicatively coupling (e.g., pairing or connecting) a user device to a vehicle for the duration of a ride. Further, the techniques of this disclosure improve a user-experience by preemptively determining user's preferred configurations (e.g., preferences/settings) and applying them in the vehicle while the user is transported to their destination. Moreover, the techniques of this disclosure ensure that residual data does not impact subsequent rides or user experiences by facilitating a wireless connection for the duration of the ride using an identifier of the user device such that any given vehicle displays to the user as an alias.

In some examples, a user may hail a ride with their user device. For example, a user in an environment may transmit a request for transportation from their current location (or, e.g., a defined starting location) to a destination location. The request for transportation may be transmitted by a user device with which the user is associated. For example, the user may use a smartphone or tablet, a smart watch, a computer application or website, and so on, to request transportation. The request for transportation may be transmitted via an application or service (e.g., a rideshare service) on the user device.

In at least some examples, a remote computing resource (e.g., associated with a smartphone application) may receive the request for transportation. The remote computing resource may, among other things discussed in more detail throughout this disclosure, determine a vehicle in an environment best suited to execute the request for transportation. For example, the remote computing resource may determine a preferred or optimal vehicle to transport the user based on a starting and/or destination location indicated by the user, a group size of the user, a vehicle preference indicated by the user, and so on. The remote computing resource may balance or compare myriad factors and conditions to determine which vehicle is most appropriate for transporting the user (thereby fulfilling the request for transportation).

In some examples, a user may be a first-time user, meaning the user has not previously requested transportation (or been transported) by the application or service. In some examples, a first-time user may refer to a user who has not previously coupled their user device to a vehicle in the fleet via a short range wireless communication. In other examples, a user may be a repeat-user, meaning the user has previously requested transportation (or been transported) by the application or service on one or more occasions. The techniques discussed herein may be applied to either use case, in addition to or in lieu of myriad others contemplated herein.

In some examples, a vehicle may be an autonomous or semi-autonomous vehicle configured to execute the request for transportation at least partially autonomously. For purposes of clarity and not limitation, “vehicle” is used throughout this disclosure. However, one of ordinary skill in the art will understand and appreciate that the techniques of this disclosure may be applied to human-operated vehicles (e.g., non-autonomous), partially autonomous vehicles (e.g., driver-monitored or assisted), fully autonomous vehicles (e.g., driverless), and so on.

In some examples, when the remote computing resource determines an appropriate or optimal vehicle of a fleet of vehicles, it may transmit, to the vehicle, route data associated with transporting the user to their indicated destination location. In such examples, the vehicle may receive the route data. The route data may comprise high-level location or trajectory information (e.g., a starting location and a destination location, without specific maneuvers or turns in between), and/or may comprise more detailed/granular data and information associated with the user's request for transportation (e.g., a starting location and a destination location, in addition to specific maneuvers or turns along the way). In some examples, the route data may comprise various additional information, such as annotated map data, traffic or weather conditions, and so on. In other examples, as discussed in more detail below, the vehicle may be configured to determine the route data and associated information (e.g., it may be stored locally and/or the vehicle have access to a remote computing resource that stores such information) rather than receive it.

In some examples, the vehicle may additionally or alternatively receive an identifier associated with a user device, where the user device is associated with the user who requested transportation. For example, a user requesting transportation may do so via a user device (e.g., smartphone) owned or operated by the user. As discussed in more detail below, the identifier may be a unique device number or identity and may comprise a public key and/or a cryptographically secure private key.

As a more concrete nonlimiting example, the user device may be Bluetooth-enabled, and the vehicle may also be Bluetooth-enabled, meaning both the user device and the vehicle are capable of pairing or bonding with other Bluetooth-enabled device(s) (e.g., via a Bluetooth protocol). In such an example, the identifier associated with the user device may comprise a Bluetooth Device Address (BDA) (e.g., “BD_ADDR”), which may comprise a 48-bit (or otherwise) unique identifier. The BDA may comprise a manufacturer portion (e.g., the first 16 bits) associated with a manufacturer of the device, an upper address portion (e.g., 8 bits) associated with a category or class of the user device, and/or a lower address portion (e.g., 24 bits) associated with a device-specific unique portion. The vehicle may comprise a separate BDA in a similar or a different format.

In some examples, the identifier associated with the user device may comprise an address-randomization component, which may improve security and privacy of wireless connections. In such examples, the user device may comprise a resolvable random address (RPA). Keeping with the Bluetooth example, the vehicle and the user device may be configured to communicatively couple via a standard or classic protocol (e.g., BR/EDR), via a Bluetooth Low Energy (BLE) secure connection, or otherwise.

In other examples, the user device(s) and/or vehicle(s) may comprise myriad additional or alternative identifier types, formats, or addresses. For example, a media access control (MAC) address, an internet-protocol (IP) address (e.g., static or dynamic), international mobile equipment identity (IMEI), international mobile subscriber identity (IMSI), integrated circuit card identifier (ICCID), serial number, universally unique identifier (UUID) or globally unique identifier (GUID), device ID, asset tag or inventory ID, or any combination thereof may be used to identify any given user device and/or vehicle. For example, the application or service through which the user requests transportation may store or have access to a database or inventory of users and their associated device identifiers. In some examples, the identifier(s) may be static, meaning the identifier for any given user device may not change over time. In other examples, the identifier(s) may be dynamic, meaning an identifier associated with any given device may be modified or randomized (e.g., at time intervals, after conclusion of transportation, etc.). One of ordinary skill in the art will understand and appreciate the myriad formats and styles of device identifier(s) as well as the various methods or processes that may be leveraged to determine or generate device identifier(s).

In examples, the identifier may be configured to establish a wireless connection (e.g., short-range communication connection) with other device(s) proximate the user device (e.g., via near-field communication or Bluetooth). For example, the identifier may be used to communicatively couple the user device to a vehicle via a wireless connection. For example, the identifier may be used facilitate a communication connection between the user device(s) associated with the identifier and the vehicle which has been allocated to or tasked with transporting the user to their destination.

In some examples, when the vehicle receives route data associated with transporting the user to their destination, the vehicle may simultaneously or near-simultaneously receive the identifier associated with the user device. The vehicle may determine information associated with the identifier before the vehicle arrives at the starting location to pick up the user. In such an example, the vehicle may receive the identifier associated with the user device and may retrieve or otherwise determine configuration data associated with the identifier. As used throughout this disclosure, “configuration data” may comprise audio configuration data or settings (e.g., volume, equalization, device priorities, playback control preferences), vehicle cabin settings or preference(s) (e.g., lighting, microphone function, ambiance, heating, venting, and air conditioning (HVAC), handoff procedure settings), and so on. These examples are intended to be illustrative rather than limiting, and one of ordinary skill in the art will understand and appreciate the myriad settings, preferences, and/or components of a vehicle that may be modified to reflect a user's preferred experience. At least a portion of the configuration data may be modified by the user (e.g., via their user device) for the duration of the wireless connection between the vehicle and the user device. In other words, establishing a wireless connection may allow a user to control or modify, via their user device, at least some aspects of configuration data (e.g., interior lighting, volume settings and other audio configuration data, etc.). The examples

As a more concrete nonlimiting example, the vehicle may determine myriad configurations or preferences associated with a user profile that may be linked to or associated with the identifier. For example, the vehicle may access a remote computing resource storing configuration data associated with device identifiers, and “preload” the corresponding preferences, settings, etc., into the vehicle prior to picking up the user.

In at least some examples, the vehicle may refrain from broadcasting (e.g., outwardly advertising) an available wireless connection until the occurrence of an initiation event or threshold. That is, although the vehicle may determine configuration data associated with the identifier prior to picking up the user, it may refrain from broadcasting the availability of a wireless connection (e.g., to the user device and others). Doing so may prevent interception or intrusion by malicious actors and may generally streamline the connection process between the user device and the vehicle.

In examples, once the initiation event occurs and/or the initiation threshold is satisfied, the wireless connection between the vehicle and the user device may be configured. Configuring the wireless connection may comprise broadcasting (e.g., publicly advertising) the available communication connection. In some such examples, upon the occurrence of the initiation event or satisfaction of the initiation threshold, the vehicle may transmit or broadcast an available wireless connection. In keeping with the Bluetooth example discussed above, doing so may comprise causing the user device to display an available Bluetooth-enabled device connection (e.g., “User A's Vehicle”). In an example where the user is a first-time user, broadcasting the available communication connection may display to the user as a new device available for pairing or bonding. In an example where the user is a repeat user, broadcasting the available communication connection may display as a device with which the user device has previously paired or bonded. Even when a unique vehicle that the user device has not previously communicated or connected with is assigned to the request for transportation, the techniques discussed herein allow the user to connect to the unique vehicle without having to first pair or bond with it, irrespective of their lack of prior association. For example, by leveraging remotely stored or accessible identifier(s) associated with each user device, the user device(s) may initially pair or bond with a vehicle in a fleet of vehicles, and then subsequently reconnect with other vehicle(s) in the fleet, notwithstanding a lack of prior connection to the other vehicle(s).

In some examples, configuring the wireless connection may comprise prompting the user, via the user device, to accept or confirm a wireless connection attempt. For example, configuring the wireless connection may comprise prompting the user to input data to confirm the identity of the vehicle and/or the user. For example, the user may be prompted to input a user PIN number or similar confirmation code displayed (e.g., via a graphical user interface (GUI)) or provided (e.g., via speaker(s)) by the vehicle. Examples where the user is prompted to confirm their identity (or the identity of the vehicle) may be indicative of a first-time user who has not previously paired or bonded their user device with a vehicle associated with the application or service. In other examples, the security and privacy of the wireless connection may be improved by prompting each user to confirm the identity of their user device (or of the vehicle). As such, a repeat user may similarly be prompted to do so, notwithstanding their previous bond or pair with a vehicle associated with the application or service.

In another example, configuring the communication connection may additionally or alternatively comprise broadcasting the vehicle's availability (e.g., public address) to nearby wireless connection-enabled device(s). For example, the vehicle may transmit its public (or publicly accessible) address such that other device(s) proximate the vehicle can communicatively couple to the vehicle. For example, in keeping with the Bluetooth example from above, broadcasting the vehicle's available wireless connection may cause nearby wireless connection-enabled user devices to display the vehicle's identity or alias as an available wireless connection.

Additionally or alternatively, the vehicle may comprise an identifier. The identifier associated with a vehicle may comprise a public key and/or a private key pair. A user device may, to configure the wireless connection, access a public key associated with the vehicle. The user device may, by virtue of being a validated member or participant with the application or service, have access to a remote data store or computing resource that stores vehicle identification information (e.g., identifiers and associated public and private keys). The user device(s) may at least in part use a private key associated with the vehicle to configure the wireless connection. For example, a private key associated with the vehicle may be used by the user device to determine vehicle data sufficient to configure the wireless connection. One of ordinary skill in the art will understand and appreciate the use of public and private keys to configure a wireless connection.

For purposes of this discussion, “remote data store” is used to denote any remotely accessible computing resource capable of storing (e.g., as an inventory) data. For example, a remote data store may comprise a database or server connected to a network and configured to transmit and receive data. In another example, a remote data store may comprise a vehicle in a fleet of vehicles (e.g., the same vehicle with which a user wishes to communicatively couple their vehicle and/or an alternative vehicle in the same or a different fleet of vehicles). In another example, a remote data store may comprise a user device, which may be configured to store user profile settings/preferences, and so on. Other remote data store(s) are contemplated herein, and one of ordinary skill in the art will understand and appreciate the myriad techniques, processes, and/or components which may be configured to store, retrieve, or otherwise provide data to a vehicle and/or user device according to the techniques herein.

In an example where the wireless connection between the vehicle and the user device comprises a Bluetooth protocol, the identifier associated with the user device and the identifier associated with the vehicle may each comprise or have access to a shared secret key (e.g., a symmetric key that may be used for symmetric key encryption). In such an example, when a user device has previously paired or bonded with a vehicle associated with an application or service (e.g., one of a plurality of vehicles in a fleet), the user device and/or other vehicles associated with the application or service (e.g., other vehicles in the fleet) may store or have access to a secret key (e.g., a symmetric key as stored by a remote data store). In such an example, the vehicle and the user device may leverage the shared secret key for both encryption and decryption, according to a wireless connection Bluetooth protocol, contemplated herein.

In some examples, as noted above, the wireless connection may not be configured until the occurrence of an initiation event and/or the satisfaction of an initiation threshold. An initiation event may be a more discreet or recognizable instance, whereas a threshold may be a more passive limit or boundary. For example, an initiation event may be the moment when a user ingresses the cabin of the vehicle and the vehicle door closes. In other examples, the initiation event may be when the user is in the vehicle and the vehicle begins navigating a trajectory toward a destination.

An initiation threshold may be a distance between the vehicle and the user device. For example, the wireless connection may be configured when the vehicle is within a threshold distance (e.g., 5 meters, 10 meters, 1 mile) from the user device. In another example, the initiation threshold may be a threshold amount of time (e.g., duration). For example, the initiation threshold may be satisfied when the vehicle is within a threshold duration (e.g., 2 minutes, 10 minutes) of arriving at the starting location (or user device). In another example, the initiation threshold may be a threshold network or connection signal strength (if, e.g., the vehicle and the user device have previously paired or bonded).

In some examples, based at least in part on configuring the wireless connection between the vehicle and the user device, configuration data may be presented in the vehicle. Once the initiation event has occurred or the initiation threshold has been satisfied, the vehicle may be sufficiently confident that the user associated with the user device is the correct user, and configuration data associated with the user may be presented. For example, a user's lighting and ambiance preferences may be displayed in the cabin of the vehicle once the wireless connection is configured. As another example, presenting the configuration data may comprise allowing the user device to at least partially control or input data to an audio system component or module of the vehicle. Doing so may allow the user, via their user device, to play their own audio (e.g., music or podcasts), control playback (e.g., skip or play/pause), modify settings (e.g., equalization or volume) or otherwise implement their own audio preferences for the duration of their transportation.

In at least some examples, presenting configuration data may comprise allowing the user to control lighting and temperature/HVAC controls with their device. In another example, presenting configuration data may comprise allowing the user to interface with or use microphone(s) onboard the vehicle (e.g., to communicate with a remote operator or to take phone calls while in the vehicle). In another example, presenting the configuration data may comprising configuring the vehicle to function as a network-access point. For example, doing so may configure the vehicle to broadcast a Wi-Fi signal such that user(s) in the vehicle can connect their device(s) to the Wi-Fi signal and thereby be connected to the internet. In at least some examples, presenting configuration data may comprise causing the vehicle to communicate with other entities or components (e.g., via a network). For example, presenting configuration data cause the vehicle to communicate with third-party music or media vendors to display or present audio or other data by the third-party media vendors. For example, a user may cause the vehicle to connect to a third-party music vendor and may control the playback using their user device. In another example, the user may cause the vehicle to communicate with a third-party media streaming service (e.g., YouTube, Netflix), and may present, to the user (e.g., via a graphical user interface) in the vehicle, media streamed from the third-party media streaming service.

In some examples, at the conclusion of the transportation (e.g., the user is dropped off at their destination, thus fulfilling the transportation request), a user profile associated with the identifier of the user device may be generated (if, e.g., the identifier is not already associated with a user profile) and/or updated. Updating the user profile may comprise storing the identifier (if, e.g., the user is a first-time user), and/or may comprise updating or modifying configuration data associated with the user profile to reflect updated preferences/settings, and so on. Additionally or alternatively, at the conclusion of the transportation (e.g., the transport or service has been fulfilled), the wireless connection may be disconnected. Rather than the user device unpairing or unbonding (which may require re-pairing or re-bonding), the vehicle may update configuration data associated with the identifier of the user device and disconnect the wireless connection between the vehicle and the user device. Doing so may make subsequent wireless connections more efficient and may prevent the collection of residual or stale data on both the user device and the vehicle.

The techniques discussed herein streamline communication connection(s) between user device(s) and vehicle(s) by saving or storing configuration data in association with an identifier associated with the user device(s). Doing so provides myriad benefits. For example, a repeat user requesting transportation in a geolocation different than where they previously requested transportation will be capable of connecting to a different vehicle without re-pairing or re-bonding with the different vehicle. In such an example, a user who has previously paired or bonded with a vehicle associated with the application or service may, when requesting transportation in a different city or country, be presented with a vehicle alias (e.g., User A's Vehicle) in their list of previously connected devices. For example, notwithstanding the model number or identity of a specific vehicle in fleet of vehicles allocated to the user's request for transportation, the techniques herein allow a user to communicatively couple to the vehicle without re-pairing or re-bonding each time they ride. In other words, by leveraging the techniques discussed herein, any given vehicle in a fleet of vehicles may be configured to facilitate a streamlined and efficient wireless connection to the user's device(s). Doing so improves the user experience by simplifying the wireless connection process and preventing garbage data or stale devices from convoluting a list of previously connected device(s).

Additionally or alternatively, the techniques of this disclosure help limit or prevent the collection or accumulation of residual (e.g., garbage) data. For example, for both the user device and the vehicle, the techniques herein reduce the quantity of previously paired devices. For example, a user device may connect or couple to one hundred unique vehicles associated with an application or service and will maintain just one vehicle alias associated with all the vehicle(s). For each vehicle that the user device attempts to configure a wireless connection with, the available connection may display as “User A's Vehicle.” Doing so prevents the buildup of stale, previously connected device(s) stored or displayed by the user device. A user's experience is thereby improved by allowing seamless connection(s) between a plurality of vehicles without accumulating a long and incoherent list of previously connected devices. A similar benefit is derived by the vehicle and the remote computing resource associated with the vehicle, which may be one of a plurality of vehicles in a fleet.

Additionally or alternatively, the techniques of this disclosure may improve the functioning and security of a computing system and/or device (e.g., a vehicle or user device). For example, by avoiding a pairing or bonding procedure between a vehicle and user device for second and subsequent connections, a computing system and/or device reduces the quantity and frequency of unnecessary or superfluous signal broadcasting and data transmission. Doing so also avoids exposing user device(s) and/or vehicle(s) to potentially malicious device(s). Further, wireless connection and network security is improved by reducing the likelihood of and vulnerability to interception and/or interruption by potentially nefarious device(s) or user(s). For example, by streamlining wireless connections between vehicle(s) and user device(s), potential interception, intrusion, or interruption vectors are minimized and reduced, thereby improving network security.

The techniques described may be implemented in a number of ways and contexts. For example, although discussed herein for purposes of illustration as being applied to an at least-partially autonomous vehicle, the techniques may be applied to any combination of non-autonomous, semi-autonomous, and/or fully autonomous vehicle(s) which may be associated with or operated by an application or service (e.g., multiple different vehicles operated by a rideshare company or by a rental car company, and so on).

Additionally or alternatively, although many of the examples are described from the perspective of a vehicle operating in an environment, any of the techniques, methods, or processes discussed may be applied or implemented by a remote computing resource and/or a user device(s). For example, the techniques discussed may be implemented by a remote computing resource and may be transmitted or communicated to a vehicle and/or a user device. Myriad additional and alternative use cases are contemplated herein.

Further, although discussed in the context of vehicle(s), the methods, systems, and techniques described herein may be applied to a variety of systems or contexts and are not limited to autonomous or semi-autonomous vehicles (e.g., mobile robots). For example, the techniques applied herein may be applied to a variety of device(s) that may communicatively couple to other device(s) via a wireless connection. For example, the techniques may be applied to connection(s) between user device(s) and other vehicles such as boats, aircraft, all-terrain vehicles (ATVs), drones, and so on.

Additionally or alternatively, although many of the examples are associated communicatively coupling a vehicle and a user device, the techniques may be applied to facilitating connection(s) between any number of personal device(s) (e.g., smartphones, tablets, laptops, smartwatches, fitness tackers, earbuds or headphones, smart glasses), automotive or transportation devices (e.g., infotainment systems, hands-free calling, motorcycle helmets, electric scooters or bicycles, drones), audio and entertainment devices (e.g., Bluetooth speakers, home theater systems, smart TVs and media players, gaming consoles and controllers, musical instruments), smart home and internet-of-things devices (e.g., smart locks, smart lights, thermostats, home assistants, security cameras and sensors), health and fitness devices (e.g., heart rate or blood sugar monitors, smart scales, medical alert systems), key finders (e.g., Tile, AirTag, or similar for tracking items), hearing aids, remote controls (e.g., for cameras, smart home devices, TVs) and so on. One of ordinary skill in the art will understand and appreciate the myriad devices that may be communicatively coupled according to the techniques of this disclosure.

The examples provided herein are merely provided for purposes of clarity and are intended to be illustrative rather than limiting. One of ordinary skill in the art will understand and appreciate that the techniques discussed herein may be applied to a wide variety of contexts (e.g., other machinery or robotics, warehouse logistics, etc.). Example implementations are provided below with reference to the following figures.

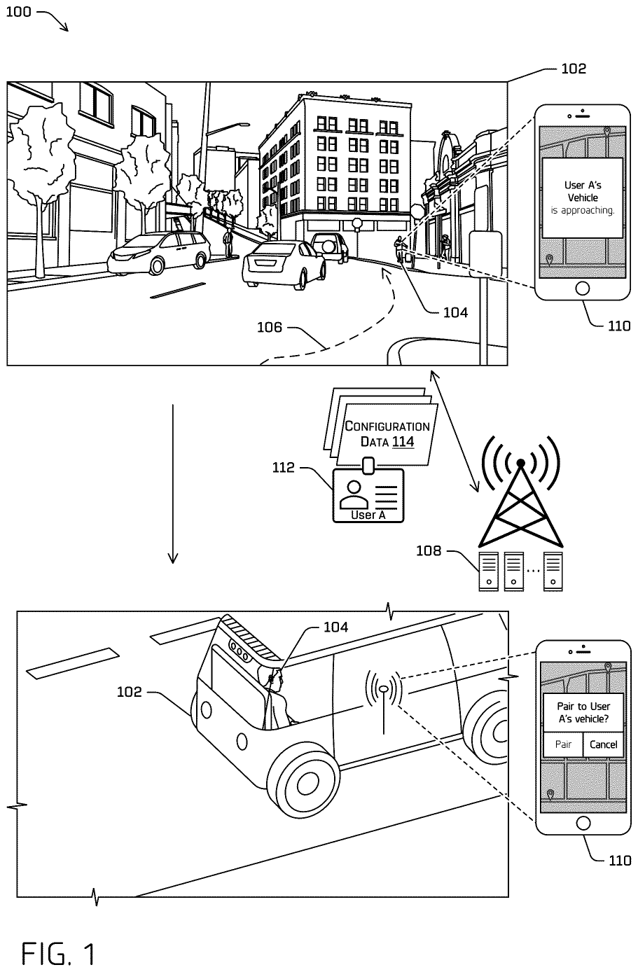

FIG. 1 illustrates an example environment 100 configured to implement the one or more of the examples of this disclosure. As depicted for purposes of clarity and not limitation, example environment 100 may comprise a vehicle 102 navigating toward and a user 104 via route date 106. As depicted for purpose of clarity and not limitation, vehicle may be shown from a first-person point of view. For example, vehicle 102 may be a representation of sensor data captured from one or more of the vehicle 102's sensors or components (e.g., a camera proximate the front bumper of the vehicle or a LIDAR system on top of the vehicle 102).

In some examples, a remote computing resource (e.g., remote computing resource 108) may receive a transportation request from user 104. The user 104 may transmit a transportation request from a user device 110. For example, user 104 may transmit a transportation request from a starting location to a destination location. The starting location may be a current or planned location of the user 104 (e.g., as determined by a location of the user device 110).

In some examples, the transportation request may be received by a remote computing resource operated by or associated with a service or application. For example, the user 104 may transmit the transportation request using a rideshare service. The remote computing resource may own, operate, or otherwise be associated with a plurality of vehicle(s) in an environment (e.g., a fleet of rideshare or rental vehicles).

A remote computing resource may receive the transportation request and determine an appropriate or optimal vehicle to transport the user 104 to their destination. Such a determination may be made based on a combination of myriad factors. For example, a proximity (e.g., distance) from a vehicle to the user 104, user-indicated preferences for a specific type of vehicle (e.g., SUVs rather than sedans, trucks rather than vans), cargo space preferences indicated by the user (e.g., more cargo space for a ride to the airport to accommodate luggage), weather conditions (e.g., all-wheel drive may be preferred over two-wheel drive), and so on, may be used individually or in combination to determine an appropriate or optimal vehicle to execute the transportation request. One of ordinary skill in the art will understand and appreciate the plurality of conditions and/or factors that may be compared to determine which vehicle in a fleet of vehicles is appropriate or optimal.

The remote computing resource may allocate or transmit route data to the determined vehicle. The vehicle 102 may then receive route data 106 associated with transporting the user 104 to their destination.

In some examples, the user 104 may transmit a request for transportation directly to a vehicle 102. For example, a user 104 may, via a user device 110, transmit a transportation request to a vehicle 102 that they own or operate, without routing their transportation request through an application or service. In such an example, the vehicle 102 may be communicatively coupled to the user device 110 and may receive the transportation request from the user device 110. In such an example, rather than receiving the transportation request from a remote computing resource (e.g., that received the transportation request and allocated associated route data 106 to the vehicle 102), the vehicle 102 may receive the transportation request from a user device 110 (e.g., via one or more network(s)). Such may be the case, for example, where a user 104 owns or operates an autonomous or semi-autonomous vehicle and “hails” it remotely from their user device 110.

In some examples, the vehicle 102 may additionally or alternatively receive an identifier 112 for configuring a wireless connection to the user device 110 associated with the user 104. The identifier 112 may be received simultaneously with the route data 106, and/or may be received after receiving the route data 106. For example, the vehicle 102 may begin traversing a trajectory toward the starting location of the route data 106 before receiving the identifier 112.

As discussed above, the identifier may represent a specific number or identity associated with the user device 110. The identifier 112 may be configured in many ways (e.g., manufacturer-assigned, or as determined by a Bluetooth protocol), and may be configured to establish a wireless connection with other device(s). For example, the identifier 112 may be a public address associated with the user device 110, and/or may be accessible or discoverable by one or more device(s) proximate the user device 110. In the Bluetooth example from above, the identifier 112 may be a Bluetooth Device Address (BDA) (e.g., “BD_ADDR”) configured to allow other device(s) proximate the user device 110 to identify the BDA and to establish a wireless connection with user device 110 (e.g., by exchanging keys and/or a private ‘shared secret’). In at least some examples, an identifier 112 for any given user or user device may be determined prior to the user requesting transportation. For example, an identifier 112 may be determined or assigned when a user configures an account with an application or service associated with one or more vehicle(s). For example, when a user registers an account (using their user device) with the application or service, the identifier 112 may assigned or allocated, and may be stored (e.g., in a remote data store) for use by subsequent vehicles. In another example, the identifier may be assigned when the user transmits a service request. For example, the user device may not be associated with an identifier 112 until they submit or transmit a request for transportation.

Upon receipt of the route data 106, the vehicle 102 may navigate to a starting location (e.g., to pick up the user) as indicated by route data 106. The vehicle 102 may traverse the environment toward a starting location, which may be the current location of the user device 110 (e.g., presumably, the user device 110 is on the user 104's person or nearby). In another example, the starting location may be a defined located as indicated by the user 104. Such may be the case, for example, if the user 104 transmits a transportation request for a different user (e.g., a friend) who is in a different location. Further, such may be the case if the user is expecting to be in a different location when they wish to be transported (e.g., they are scheduling a transportation request for a different time or enroute to a different location).

In some examples, the vehicle 102 may determine a satisfaction of an initiation threshold. For example, the vehicle 102 (or, e.g., a remote computing resource) may monitor the geolocation of the vehicle 102 relative to the user device 110. The initiation threshold may be a physical distance or proximity (e.g., 1 meter, 10 meters, 2 city blocks) between the vehicle 102 and the user device 110 that transmitted the transportation request. In another example, the initiation threshold may be a signal range or detection threshold between the vehicle 102 and the user device 110. For example, Bluetooth may be configured to detect other device(s) within a 10-30-meter range, and such a range or radius may constitute the initiation threshold.

In another example, the initiation threshold may be a latency limit or signal strength between the vehicle 102 and the user device 110 (if, e.g., the user 104 has previously connected to the vehicle 102 or to a vehicle 102 in the fleet). For example, when a latency limit between the vehicle 102 and a remote computing resource 108 and between the user device 110 and the remote computing resource 108 are sufficient similar (within a threshold latency), it may indicate that the vehicle 102 is approaching the user device 110 or is within a threshold distance from the user device 110. In another example associated with a repeat user, the vehicle 102 may be configured to transmit or receive data (e.g., packets) to/from the user device 110 associated with the transportation request. Notwithstanding an established wireless connection between the vehicle 102 and the user device 110, the vehicle 102 and/or the user device 110 may be capable of transmitting and receiving data sufficient to determine latency or signal strength (e.g., the device(s) may “ping” each other). In such an example, the vehicle 102 and/or the user device 110 my route their data through one or more network(s) or may have access to publicly available address information sufficient to route packets, but insufficient to communicate in more complicated ways.

In another example, the initiation threshold may be a duration that the transportation request is valid, or a duration from the time at which the transportation request was received or transmitted.

In other examples, the vehicle 102 may determine an occurrence of an initiation event. For example, the vehicle 102 (or, e.g., a remote computing resource) may monitor various vehicle components and systems (e.g., door locks, door sensors, near-field communication beacons, and so on) to determine the occurrence of an initiation event. For example, the vehicle 102 may monitor for a user 104 who has ingressed (e.g., entered) the vehicle 102 and closed the door. In such an example, the initiation event may be either the user 104 ingressing the vehicle 102, the door closing shut, or any combination thereof (e.g., a sensor in the vehicle 102 detects user 104 sitting in a seat and a door lock sensor detects the doors of the vehicle 102 closed).

In another example, the initiation event may be a user 104 buckling their seatbelt properly (e.g., as detected by a seatbelt sensor). In another example, the initiation event may be associated with the vehicle 102 beginning along a trajectory toward a destination. In such an example, the vehicle 102 may determine that the initiation event has occurred once the vehicle 102 begins along a trajectory, or when the vehicle 102 reaches a threshold speed or acceleration. In such an example, the vehicle 102 may determine that the initiation event has occurred only when the vehicle has reached a speed of fifteen miles per hour, thereby indicating that the vehicle 102 has completed a merge maneuver or exited a parking lot and has successfully integrated with the flow of traffic.

In another example, the vehicle 102 may determine the occurrence of the initiation event when the user 104 has ingressed the vehicle 102 and interacted with a graphical user interface (GUI) or has otherwise input user data sufficient to indicate their ingress. For example, when the vehicle 102 arrives at the starting location, the user 104 may ingress the vehicle and select a “start ride” button on a GUI inside the vehicle cabin. Additionally or alternatively, the vehicle 102 may request verbal confirmation from the user 104 that the user 104 is sitting in their seat and prepared to begin transportation. The user 104's audio configuration data may constitute the initiation event. In another example, the vehicle 102 may comprise one or more communication component(s) configured to facilitate near-field communications (NFC) with user devices. In such an example, the vehicle 102 may monitor a communication component(s) and, upon recognition of or initiation by the user device, may determine that the initiation event has occurred. In another example, the vehicle 102 may present a quick-response (QR) code or other unique visual code to the user 104 upon ingress to the vehicle 102. The vehicle 102 may determine, based on the user 104 scanning or executing the QR code, that the initiation event has occurred.

In some examples, the initiation event and/or the initiation threshold may be the vehicle 102 approaching the user or user device 110 and perceiving the user 104. For example, the vehicle 102 may capture sensor data (e.g., image data, lidar data) of the environment proximate the vehicle 102. The vehicle 102 may be configured to determine, based on sensor data captured by the vehicle 102, that the user 104 approaching the vehicle 102 is the user that requested transportation. As more concrete nonlimiting example, the vehicle 102 may have arrived at the starting location, and may be waiting for the user 104. The vehicle 102 may be configured to capture sensor data associated with the environment proximate the vehicle 102, which it may use to determine if and when the user 104 is approaching the vehicle 102. In such an example, the occurrence event may be perceiving the user 104 as they approach. Additionally or alternatively, the initiation threshold may be a confidence level associated with the vehicle 102's determination that the user 104 is approaching. In such examples, a wireless signal associated with the user device 110 may be used at least in part to determine that a user 104 approaching the vehicle is the user 104 that requested transportation.

In at least some examples, an initiation event and/or an initiation threshold may be used individually or in combination. For example, an initiation event may occur when the vehicle 102 arrives at the user 104's indicated starting location, and an initiation threshold may occur when a threshold duration has expired since the vehicle 102 arriving. In another example, an initiation event may occur when the user 104 ingresses the vehicle 102, and an initiation threshold may be satisfied when the vehicle 102 remains stationary for a threshold duration. In such an example, the user 104 may be accompanied my multiple other user(s). In this example, the initiation event may when a first user ingresses the vehicle, and the initiation threshold may be the expiration of a threshold duration after the first user ingresses the vehicle. Such a combination may indicate to the vehicle 102 that the user 104 is ready to configure a wireless connection while the rest of user(s) ingress the vehicle 102, sit down, and buckle their seatbelts.

As depicted in the example environment 100 for purposes of clarity and not limitation, the initiation event may occur when the user 104 ingresses the vehicle 102 and the doors of the vehicle 102 are closed. Such an initiation event may limit the possibility of malicious actors intercepting or otherwise interrupting the user 104's experience by ensuring that the wireless connection can be configured or established only when the user 104 ingresses the vehicle 102.

In some examples, the vehicle 102 may configure a wireless connection with the user device 110 based at least in part on the occurrence of an initiation event and/or upon satisfaction of an initiation threshold. Configuring the wireless connection with the user device 110 may comprise, for example, broadcasting (publicly presenting) an available wireless connection. For example, the vehicle 102 may, upon determining that an initiation event has occurred (e.g., User A ingresses the vehicle), display a publicly connectable alias for nearby device(s) to connect to (e.g., “User A's Vehicle”). For example, user 104 may, via their user device 110, establish a wireless connection by selecting “User A's Vehicle” from a list of available wireless connections.

In some examples, the vehicle 102 may prompt a user to confirm the wireless connection using a prompt on their user device 110 and/or via a GUI in the cabin of the vehicle. For example, the vehicle 102 may present a prompt to the user 104 on their user device 110 that requests a PIN number or similar confirmation code displayed on a GUI in the vehicle. The user 104 may confirm their identity by inputting the confirmation code into their user device. In another example, the vehicle 102 may present to the user 104, via the user device 110, a confirmation code. To confirm the user 104 identity and accept the wireless connection, the user 104 may input the displayed confirmation code to a GUI in the cabin of the vehicle (or, e.g., verbally confirm the code by audibly speaking it in the cabin of the vehicle equipped with microphone(s)). In other examples, the wireless connection between the vehicle 102 and the user device 110 may be configured or established by the user 104 selecting the vehicle 102's broadcasted alias from a list of available devices.

In some examples, the identifier 112 may be associated with configuration data 114. Configuration data 114 may comprise myriad data or information associated with the user 104's preferences, settings, and/or inputs. For example, configuration data 114 may comprise audio configuration data and controls (e.g., playback controls, volume preferences, equalizer settings), lighting and ambiance preferences (e.g., brightness, colors palette, saturation, percentage of window tint or darkness), heating and air conditioning preferences (e.g., temperature, fan speed, seat warmer settings), microphone preferences (e.g., enable or disable cabin microphone(s)), seating preferences (e.g., lumbar support, seat position, headrest position), and so on. Configuration data 114 may comprise myriad settings, preferences, actions, controls, or otherwise which a user 104 may be capable of modifying or altering (e.g., with their user device 110) for the duration of their transportation.

For example, in the Bluetooth example from above, configuration data 114 may comprise interfaces and/or controls associated with audio playback in the cabin of the vehicle 102. Based at least in part on establishing the wireless connection between the vehicle 102 and the user 104, the user 104 may be presented, via their user device 110, with configuration data 114 inputs or interfaces. For purposes of clarity and not limitation, the cabin lights and radio volume in the vehicle may be modified or updated to reflect the user 104's preferences once the wireless connection is established (thus indicating that the user 104 has been validated).

The vehicle 102 may retrieve or otherwise access configuration data 114 (e.g., via remote computing resource 108) before the satisfaction of the initiation threshold or occurrence of the initiation event. Doing so may allow the vehicle 102 to apply or configure some components of configuration data 114 prior to the user 104's ingress into the vehicle 102. The vehicle 102 may, however, refrain from broadcasting an available wireless connection until the initiation threshold has been satisfied and/or the initiation event has occurred. For example, the vehicle 102 may download or otherwise determine at least some components of configuration data 114 which may be associated with a user profile of the user 104 as stored or associated with the identifier 112 of the user device 110. In such an example, notwithstanding an established wireless connection, the vehicle 102 may determine various preferences or settings associated with the user 104. Such preferences or settings may be stored or updated in association with a user profile, which may be associated with an identifier 112 of the user device 110. By doing so, any given vehicle owned or operated by a remote computing resource 108 may cause a user device 110 to display the same alias associated with the user 104's vehicle, notwithstanding the specific model or instance of the vehicle 102. For example, by accessing at least some components of configuration data 114 (e.g., an identifier 112 associated with the user device 110) prior to arriving at the user 104's determined starting location, the vehicle 102 may be better equipped to seamlessly connect to the user device 110.

As a more concrete nonlimiting example, a user 104 may have previously paired or bonded their user device 110 with a vehicle 102 in a fleet of vehicles owned or operated by a rideshare service. When the user 104 transmits a subsequent transportation request, the vehicle 102 allocated or assigned to the subsequent transportation request (which may be a unique vehicle that the user has not previously used) may retrieve, receive, or otherwise determine an identifier 112 associated with the user's device. The vehicle 102 may determine, based at least in part on the identifier 112, at least some components of configuration data 114, such as a public Bluetooth address of the user device 110. Despite the specific vehicle being one which the user device 110 has not previously connected to, the vehicle 102 may (upon occurrence of the initiation event) broadcast to the user's device using the same alias as used previously by other vehicles in the fleet. For example, the vehicle 102 may broadcast, and thereby caused to be displayed on user device 110, “User A's Vehicle,” notwithstanding the user 104's lack of prior experience or use with the specific vehicle.

In examples, some components of configuration data 114 may be applied or configured prior to the vehicle 102 establishing the wireless connection with the user device 110. In such examples, low-control or otherwise minor modifications may be made to cabin lighting, lumbar support, cabin temperature, and so on, prior to the initiation threshold being satisfied or initiation event occurring. In examples, the user 104 may not, however, have access to or be capable of making any changes to such configuration data until the user device 110 has established the wireless connection. For example, although cabin lighting may be modified to reflect the user 104's preferences (e.g., as determined from configuration data 114), the user 104 may not be presented with audio playback controls unless and until the wireless connection is configured.

In some examples, the user 104 may be associated with more than one user device. In such examples, the vehicle 102 and/or configuration data 114 may store or otherwise have access to priority rules associated with the user 104's multiple devices. For example, the user 104 may have a tablet, laptop, earbuds, and smartphone. The user 104 may request transportation using their smartphone, may connect their tablet and laptop to cabin Wi-Fi, and may connect their earbuds to each one of their devices in addition to establishing a Bluetooth connection with the vehicle 102. In such an example, various priority rules may govern the actions and reactions of the vehicle 102 and each user device 110. For example, the connection of the user 104's smartphone to the vehicle 102 may typically maintain the highest priority during transportation, but the connection between the user 104's earbuds and the vehicle 102 may establish a higher priority than the smartphone when the smartphone receives a phone call. In this example, the increased priority allocated to the connection between the earbuds and the vehicle 102 may cause music being played in the vehicle cabin by the smartphone to pause, phone call audio to be routed to the vehicle 102 and played by speaker(s) in the vehicle 102 cabin, and/or enable an onboard microphone such that the user 104 can speak on the phone in the cabin and hear the audio through their earbuds.

In some examples, the user 104 may be accompanied by one or more other user(s). For example, the user 104 may be the one to request transportation using their user device 110, but there may be a plurality of additional user(s) that will accompany the user 104 during transportation. In such examples, there may be a handoff or transfer process configured to allow the user 104 to allocate playback controls or other authority to a different user device. This may be done via a visual identifier code (e.g., QR code) presented by the user device 110 and scanned by the device attempting to establish authority. The user device 110 may, in some examples, wish to handoff only partial authority, meaning the receiving user device may only have the authority to control specific preferences, actions, or settings. In some examples, the handoff procedure may be accomplished via near-field communications (NFC). In such an example, the user device 110 may transmit an NFC signal, and a recipient device may be given authority upon tapping the device to the user device 110.

In another example, the vehicle 102 may display a QR code to user(s) such that scanning the QR code initiates a handoff sequence. Doing so may prompt the current user device (with current priority/authority) to authorize or reject the handoff attempt. In yet another example, the vehicle 102 may be configured monitor for NFC and to initiate or execute a handoff sequence when a user device taps their phone to a specific location within the vehicle 102 cabin (e.g., the physical playback controls or a location on the dashboard).

In at least some examples, a user device that is not user device 110 (that requested transportation) may be allocated at least partial authority to modify the configuration data during the transportation or service. For example, instead of the user device 110 initiating a handoff procedure or otherwise indicating an intent to handoff at least partial authority, a second user device (e.g., associated with another individual in the vehicle) may indicate an intent to receive at least partial authority. The second device may, for example, tap their phone to a near-field communications prompt or scan a QR code in the cabin of the vehicle. By doing so, the vehicle may allocate at least partial authority to the second device such that the second device can modify or manipulate at least a portion of configuration data. For example, the second device may scan a QR code and may be allocated the authority to control their personal HVAC vents (e.g., the ones pointed at them or on their side of the vehicle) or seat heating/cooling settings. In another example, a second user (e.g., a fellow rider in the same vehicle) associated with a second device may tap their phone to an NFC module and may be granted permission to control playback and/or volume of the audio configuration data presented in the vehicle. In at least some such examples, the user device 110 that was responsible for requesting transportation may be prompted to confirm or authorize the partial transfer of authority. The user device 110 may authorize the second device's request for authority, deny it, or elect to maintain the same authority permissions across each device. In the latter example, the user associated with user device 110 may not be willing to relinquish total audio playback control and may wish to maintain at least some playback control(s) (e.g., volume settings or playback controls, or both). In some such examples, the second device may indicate their desire for at least partial authority at any time during transportation.

In at least some examples, a second user device may be allocated at least partial authority/permissions only if they authorize or confirm the receipt of such authority/permissions. For example, a user who requested transportation using a first user device may initiate or trigger a handoff procedure (e.g., by specifying which configuration data and/or control(s) they wish to handoff). Upon doing so, a second user may, via their second user device, receive a prompt indicating the attempt to handoff at least partial authority. The second user may first authorize or confirm their willingness to receive the authority that the first user is attempting to handoff. In another example, the first user may initiate or facilitate a handoff procedure to a second user device of a second user, and the second user may not need to first confirm or authorize the handoff (e.g., the second user automatically receives the authority/permission).

In at least some of the examples above with regard to a handoff procedure, the second user (e.g., receiving at least partial authority to modify configuration data) may be a member or participant with the same application or service as the first user (e.g., the user who requested transportation and who may attempt to relinquish at least partial authority). In another example, the second user may not be a member or participant with the same application or service. In such an example, the second user may not be associated with a user profile associated with the application or service, and their user device may not have an identifier stored or retrievable by the vehicle. In some such examples, upon successful handoff of at least partial authority, the techniques discussed herein may facilitate generation or creation of a temporary or guest user profile associated with the second user. The temporary or guest user profile may be stored in association with an identifier such that the second user's preferences and settings (e.g., configuration data) may be retrievable in subsequent rides. In some examples, the second user's lack of participation or membership status with the service or application may affect the level of permissions or authority that they are capable of receiving (e.g., may be authorized to modify the volume in the vehicle and control playback, but may not be authorized to indicate a ride-style or ambiance preference).

In other examples, a second user associated with a second user device (e.g., a user different than the one who requested transportation) may configure a wireless connection (e.g., Bluetooth) to the same vehicle that the first user is wirelessly connected to. For example, instead of initiating a handoff procedure, the vehicle may instead be configured to allow simultaneous wireless connections between more than one user device. In such an example, the second user may configure a wireless connection between the vehicle and their user device notwithstanding wireless connection(s) with other user device(s). In such an example, the vehicle and/or a remote computing resource may be configured to determine what permissions and/or authority belong to each user device. For example, the first user's user device and the second user's user device may each individually be wirelessly connected to the vehicle (and, e.g., may not be associated with or connected to each other). In such an example, the vehicle may receive data and communication signals from both the first user's device and the second user's device and may determine what permissions/authority each user device may have, which may affect what configuration data each user device may be authorized to modify. As a more concrete nonlimiting example, the vehicle may determine that the first user's device (e.g., a primary user who requested transportation) may be granted greater authority to modify ambiance, lighting, and ride-experience preferences, and/or that the second user's device (e.g., a secondary user who is ridesharing with the primary user) may be granted fewer permissions and may only have control over volume levels and playback controls.

In another example, the vehicle may be configured to determine what authority/permission to handoff from the first user device to the second user device. For example, the second user's lack of participation or membership with an application or service associated with the vehicle may impact the first user's authority to modify configuration data. In such an example, the vehicle may determine that the second user device should only be authorized to control certain configuration data. As a more concrete nonlimiting example, the second user may connect their user device to the vehicle and may attempt to modify a seat heating/cooling preference for their current seat in the vehicle. In such an example, the vehicle may determine that because the second user is not an authorized participant/member with the application or service associated with the vehicle, they are authorized to modify only the seating heating/cooling preference of their own seat, and are not authorized to make any other changes or modifications to the vehicle or its configuration data. In an additional nonlimiting example, the vehicle may determine that the second user is authorized to raise or lower a window on the second user's side of the vehicle, but that they are not authorized to control HVAC settings. The vehicle may determine such based on the second user's membership status or level (e.g., they are not an active participant with the application or are a not a high-enough level subscriber, whereas the first user is), the first user's indicated preference(s) (e.g., the primary user may indicate a preference to disallow other user's from modifying HVAC settings in the vehicle cabin), and so on.

One of ordinary skill in the art will understand and appreciate that the examples given above are included merely for purposes of illustration and not limitation. Any of the techniques or processes of the above examples may be combined with any other technique or processes of the above examples. Myriad combinations of the above techniques and processes, as well as additional and alternative use cases, are contemplated herein.

In some examples, a transportation request may comprise a privacy request. In such examples, the user 104 may indicate a preference or requirement for a private, non-shared transportation. A user 104's authority and/or permissions may be different during a private transport than during a shared transport. For example, a user 104 may not be authorized to unilaterally turn off all seat warmers during a shared ride but may be authorized to adjust their own seat warmer or HVAC settings.

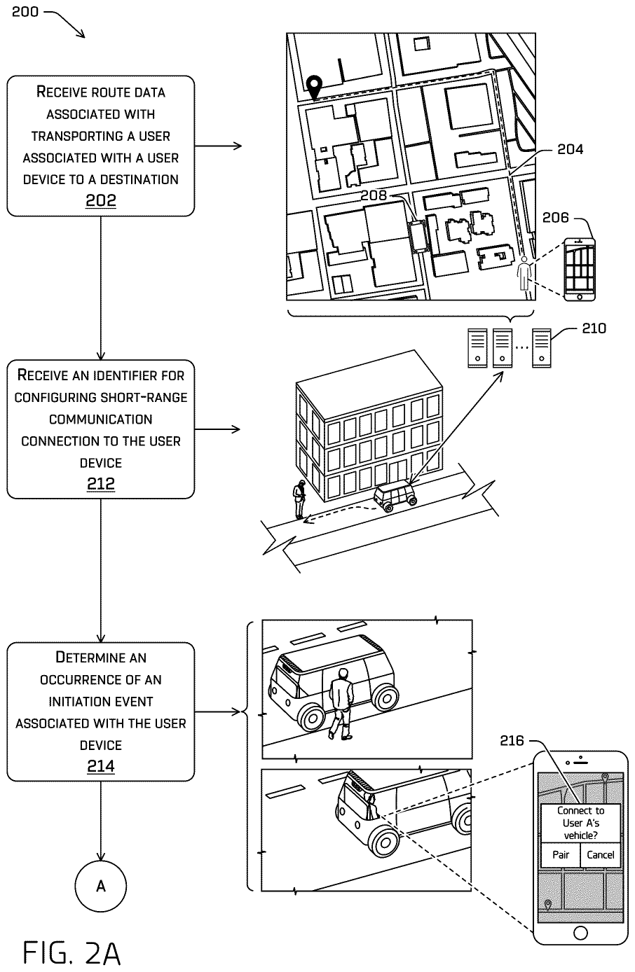

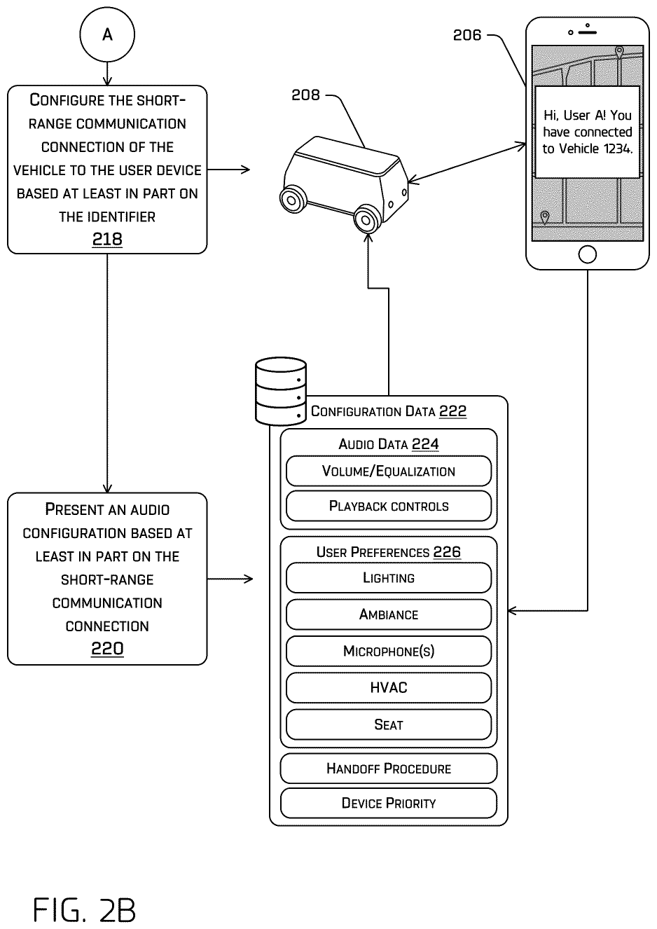

FIGS. 2A and 2B illustrate an example process 200 in accordance one or more of the techniques discussed herein. At operation 202, example process 200 may comprise receiving, at a vehicle 208 (e.g., an autonomous vehicle, which may correspond to vehicle 102), route data 204 (which may correspond to route data 106) associated with transporting a user associated with a user device 206 (which may correspond to user device 110) from a starting location to a destination location. There may be various ways or processes that cause a vehicle to receive route data associated with transporting a user to a destination. For example, although many of the examples discusses herein are in the context of a user hailing a ride using a rideshare application or similar, a vehicle may be configured to receive a transportation request in other ways. For example, a plurality of vehicles may be parked in a depot or parking lot. A vehicle may receive a transportation request from a user approaching the vehicle and communicating with the vehicle while it is parked. As a more concrete nonlimiting example, a user may approach a parked vehicle and may scan a QR code or tap their phone to a near-field communications (NFC) module associated with the vehicle that is configured to receive user indications or data. The user may tap the NFC module, which may prompt the user to input their destination location through an application or service that operates the vehicle. The vehicle may then receive, either from the user device or from a remote computing resource (e.g., that received the request and routed it to the vehicle), the transportation request. In such an example, rather than the user requesting transportation via an application on their user device, the user may request transportation by interacting with the vehicle before the vehicle has been assigned or allocated to the user's request.

In at least some examples, a user may initially configure a wireless connection between a vehicle and their user device (e.g., by NFC, Bluetooth), but may then adjust or modify configuration data using vehicle components (e.g., interior GUIs, voice-controls). For example, once a user configures a wireless connection between their device and the vehicle, the user may interact with a GUI in the cabin of the vehicle, where the GUI is configured to receive user input and to modify configuration data accordingly. For example, a user may adjust lighting settings, control audio playback, update their destination, and/or add a stop using the GUI in the cabin of the vehicle.

As a more concrete nonlimiting example, at the conclusion of a sporting event or concert, where numerous people may be leaving the venue at or near the same time, there may be a plurality of vehicles (e.g., a fleet of vehicles) outside the venue or in a nearby parking lot or depot. The plurality of vehicles may be available on a first-come, first-served basis. A person leaving the venue may approach a vehicle of the plurality of vehicles and may tap their phone to an NFC module on the vehicle or scan a QR code displayed by the vehicle (e.g., on a graphical user interface or by sticker). The person may be prompted to input data associated with the transportation request, and the vehicle may receive the data accordingly. The examples illustrated above are intended for purposes of clarity and not limitation, and many more methods or processes for causing a vehicle to receive route data associated with a transportation request are contemplated herein.

In another example, after transmission of a request for transportation, a user may be prompted to approach a specific vehicle. The user may attempt to approach the specific vehicle but may be unsure which vehicle in a lineup or fleet is the specific vehicle that they were prompted to approach (e.g., multiple identical vehicles may be parked near each other). In some examples, the user may select a vehicle (e.g., unsure if it is the specific vehicle) and scan a QR code, initialize an NFC module, or otherwise interact with the selected vehicle (e.g., may interact with a GUI on or in the selected vehicle). By interacting with the selected vehicle, a remote computing resource may reallocate or reassign the user's request for transportation to the vehicle which with the user interacted with, notwithstanding the selected vehicle being the specific vehicle that the user was prompted to approach. In other words, a remote computing resource and/or a vehicle with which the user interacts with may be configured to dynamically reassign or otherwise modify which vehicle is assigned such that the vehicle with which the user interacts with is directed to execute or implement the request for transportation.

In another example, a user may approach a vehicle and may transmit a request for transportation by scanning a QR code or initializing an NFC module. In such an example, the user may not know that they want a ride until they are standing next to the vehicle. Scanning a QR code, initializing an NFC module, or otherwise communicating with the vehicle may trigger the vehicle to open the door for the user to ingress. The user may then interact with a vehicle component (e.g., a GUI) to identify a destination, a ride-experience preference, and so on. In another example, once the user ingresses the vehicle, the user's device may be automatically connected to the vehicle (e.g., or may initialize a wireless connection according to the techniques herein), and the user may interact with the vehicle using their user device (e.g., may identify a destination, indicate a lighting preference, and so on).

In another example, a user may request transportation using their user device. The user may be directed to a nearby lineup or fleet of available vehicles (e.g., in a parking lot). The user may approach any of the vehicles in the nearby lineup or fleet and may interact with a selected vehicle. The vehicle may then receive route data associated with the user's request for transportation. In such an example, a remote computing resource may receive an indication from the vehicle that it was selected from among the lineup of vehicles, and the remote computing resource may then initialize or otherwise transmit an assignment to the selected vehicle that it is to execute the transportation request.

As discussed above, the starting location may be the current location of the user device 206, and/or may be a determined starting location as defined or selected by the user (e.g., when scheduling transportation in advance, or when requesting transportation for someone else). The route data 204 may be received from a remote computing resource 210, which may determine that the vehicle 208 is the preferred or optimal vehicle for picking up and transporting the user to the destination location.

In some examples, the route data 204 may comprise route and/or trajectory data associated with navigating to the starting location. In other examples, the vehicle 208 may determine appropriate trajectory information sufficient to arrive at the starting location. In such examples, the vehicle 208 may navigate to the starting location autonomously, without instructions or data from the remote computing resource on how to do so. That is, the vehicle 208 receive the route data 204, determine, based on the route data 204, the starting location and destination location, and may determine a route from the vehicle 208's current location to the starting location.

At operation 212, example process 200 may comprise receiving, at the vehicle 208, an identifier for configuring short-range communication connection to the user device 206. In examples, the identifier may be a public address or identity associated with the user device 206. The identifier may be retrieved or otherwise accessible to the vehicle 208 (e.g., via remote computing resource 210), and may be stored in association with a user profile associated with the user.

As depicted for purposes of clarity and not limitation, the vehicle 208 may receive the identifier prior to arriving at the starting location to pick up the user. For example, the identifier may be received at or near the same time that the route data 204 is received. The identifier may instead be received when the vehicle 208 is within a threshold proximity or distance from the user device 206, or from the starting location as indicated by the route data 204. Doing so may allow the vehicle 208 to preemptively determine preferences or settings associated with the user profile and accessible using the identifier. For example, determining lighting and ambiance preferences before arriving at the starting location may allow the vehicle 208 to apply or implement such preferences before the user ingresses the vehicle, thereby improving the user experience.

At operation 214, example process 200 may comprise determining, at the vehicle 208, an occurrence of an initiation event associated with the user device 206. For example, as depicted for purposes of clarity and not limitation, the vehicle 208 may determine, based on a location associated with the user device 206 and/or by user input data associated with the user device 206, the occurrence of an initiation event. For example, an example initiation event depicted at operation 214 is when the user ingresses the vehicle 208 and closes the door, thereby enclosing the cabin of the vehicle 208. Further, another example initiation event depicted at operation 214 is the user's selection of option(s) as presented by a dialog box 216 displayed by the user device 206. Although depicted as being displayed by the user device 206, the dialog box 216 or similar confirmation prompt (or sequence) may be displayed in a cabin of the vehicle 208 via one or more graphical user interfaces (GUIs). For example, when the user ingresses the vehicle and the vehicle begins navigating along a trajectory toward the destination, a prompt may be displayed on a GUI inside the vehicle cabin. The GUI may prompt the user (or another rider/user) for input data associated with pairing or connecting their associated user device. For example, the GUI may display a prompt that displays, “Connect User A's phone to vehicle 1234?” with options such as “Yes,” “No,” and/or “Select a different device.” In some examples, the GUI in the vehicle cabin may display a dropdown or selectable list of available devices (e.g., that have been previously paired/bonded) for the user to select.

Additionally or alternatively, in examples where the user device 206 has previously paired or bonded with one or more vehicles in a fleet owned or operated by the service or application that owns or operates vehicle 208, the user device 206 may instead present, via a dialog box or otherwise, a “Connect” confirmation. That is, in some examples, a user device 206 may pair or bond with a vehicle 208 associated with the remote computing resource 210 only a first time and may subsequently “connect” and “disconnect” from individual vehicles. The techniques of this disclosure facilitate seamless connection and disconnection between a user device 206 and individual vehicle(s) in a fleet once the user device 206 has paired or bonded with a vehicle 208 in the fleet, and the associated identifier and user profile are generated and stored by remote computing resource 210 accordingly.

In some examples, upon ingress into the vehicle 208 and/or selection of the “Pair” or “Connect” option presented to the user, the vehicle 102 may determine that the occurrence of an initiation event has occurred. At operation 218, example process 200 may comprise configuring, based on the occurrence of the initiation event and the identifier, the short-range communication connection of the vehicle 208 to the user device 206. In some examples, the operation 218 of configuring the short-range communication connection can be based on the identifier received in the operation 212. For example, the vehicle 208 and the user device 206 may initiate or execute a “handshake” or other exchange of information such that the two devices are configured to communicate via the short-range communication connection.

Configuring the short-range communication connection may configure the user, via user device 206, to manipulate, modify, control, or otherwise interact with myriad settings, conditions, preferences, or interfaces associated with the vehicle.

For example, at operation 220, example process 200 may comprise presenting, in the vehicle 208, an audio configuration based at least in part on the short-range communication connection. As depicted for purposes of illustration and not limitation, configuring the short-range communication connection may cause various configuration data (e.g., configuration data 222) and controls to be presented to the user. For example, an audio configuration 224 may be a component of configuration data 222. Audio configuration 224 may allow a user to control volume and equalization settings in the vehicle cabin, and/or to interact with playback controls to affect the sequence (e.g., queue, pause/play, skip, start over) of audio configuration 224 played in the cabin.

Additionally or alternatively, configuration data 222 may comprise myriad other components or systems adjustable to a user's preferences 226. For example, once the short-range communication connection is configured between the vehicle 208 and the user device 206, the user may have access to or be able to manipulate user's preferences 226. As depicted for purposes of illustration and not limitation, the user's preferences 226 may include indicated preferences associated with lighting, ambiance, microphone(s), HVAC, seat (heating and position), and so on. Additionally or alternatively, configuration data 222 may comprise driving style preferences (e.g., quicker or more efficient routes, trajectories, and maneuvers versus scenic and/or smoother routes, trajectories and/or maneuvers), accessibility settings (e.g., present written prompts via audio configuration in the vehicle cabin, soften audio data associated with alerts or notifications), integration with a preferred artificial intelligence component (e.g., large-language model), and so on.

In at least some examples, configuration data 222 may facilitate a user's ability to determine or indicate certain vehicle trajectories or maneuvers. For example, the user may, using their user device, indicate a desire or intention to pull over and pause the transportation. The vehicle may receive such an indication and may validate or verify the safety, feasibility, and/or practicality prior to implementing it (e.g., pulling over). In another example, configuration data 222 may allow a user to control windows, doors, suspension stiffnesses, or other vehicle components. Such control(s) may be available only during some windows (e.g., before navigation or while the vehicle is stopped). For example, a user may be authorized to control a window state (e.g., open or closed, or specific amount of open) while the vehicle is moving along a trajectory but may not be authorized to control a door state (e.g., open or closed) unless the vehicle has pulled over to a safe location and has come to a full stop. In some examples, configuration data 222 may allow a user to modify or suggest route or trajectory adjustment(s). For example, a user may indicate a desire to add a stop (e.g., grocery store or coffee shop) to the route. The vehicle may, individually (e.g., via map data and related components) or in combination with a remote computing resource, determine and/or integrate the user's modification or suggestions and adjust the route accordingly.

The configuration data 222 examples discussed herein are intended to be illustrative rather than limiting, and more configurable components and systems are contemplated herein. One of ordinary skill in the art will understand and appreciate the wide variety of vehicle components, systems, and elements that may be manipulated or modified by a user via a short-range communication connection.

In some examples, configuration data 222 may comprise a preferred handoff procedure. For example, a user may have previously executed a handoff procedure with another device via near-field communications. In such an example, if the user attempts to execute handoff procedure with a different device on a subsequent transport, the vehicle 208 may determine, based on configuration data 222 stored in associated with the identifier of the user device 206, that a NFC handoff procedure is preferred/appropriate.

Additionally or alternatively, configuration data 222 may store priority information associated with the user. For example, if the user is associated with more than one device, the configuration data 222 may store previously used or preferred priorities among the user's devices. The vehicle 208 may implement the priorities accordingly.

As discussed in more detail below, a repeat-user may be associated with a user profile, which may be associated with or comprise configuration data 222. In such an example, example process 200 may comprise updating, at the conclusion of the transportation (e.g., when the user is dropped off), the user profile to reflect updated or modified configuration settings or data. In examples where a user is a first-time user, example process 200 may comprise generating, based at least in part on the identifier, a user profile associated with the user. For example, a user profile may be associated with the identifier associated with the user device. The user profile may store or comprise various configuration settings and preferences as indicated by a user. For example, the user profile (for a first-time or for a repeat user) may store configuration data 222 and/or other settings and preferences that the user may not be authorized to modify. For example, in addition to configuration data 222 (at least a portion of which may be modified during transportation), the user profile may store payment information, suspension stiffness preferences, seat position preferences, child lock settings, and so on. The user profile may, in some examples, be a store a more complete or thorough set of user preferences. A user profile may be stored or associated with an identifier and may be received by the vehicle or may be remotely accessible to the vehicle.

In at least some examples, an example system or architecture (e.g., example environment 100) configured to implement the techniques herein may comprise a remote data store. The remote data store may be configured to store user profile(s) associated with identifiers, as discussed above. The remote data store may be remotely accessible to a plurality of vehicles operating in an environment (e.g., a fleet of vehicles) and/or to a remote computing resource. The remote data store may, for example, store user profiles associated with identifiers, which may be retrieved by vehicle(s) and/or remote computing resources. An example remote data store may be a network connected database storing user profiles, where the user profiles are locatable or searchable by identifiers. In such an example, network connected database may store user profiles in association with identifiers and may be accessible to authenticated or validated device(s), such as vehicle(s) and/or remote computing resources.

In examples, based at least in part on configuration data (e.g., audio) presented in the vehicle while transporting the user to their destination, a user profile associated with the user device may be updated to reflect configuration data 222 preferences. For example, while a user is being transported, they may adjust audio settings or preferences as presented to them in the vehicle. In such an example, a user profile associated with the user device (e.g., as identified by an identifier) may be updated to reflect the user's adjusted audio settings or preferences.

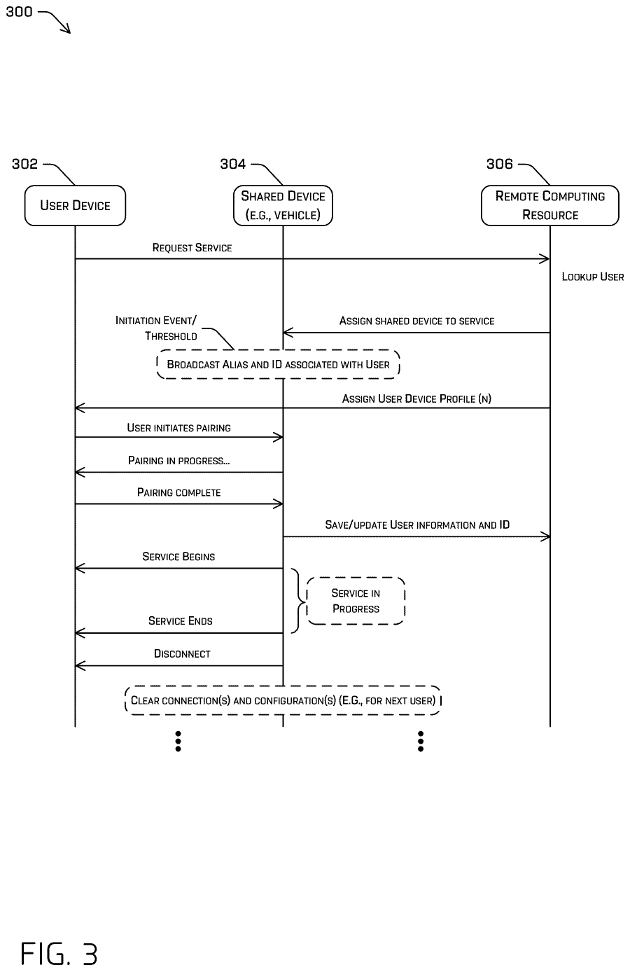

FIG. 3 illustrates an example framework 300 configured to implement one or more of the techniques discussed herein. For example, example framework 300 may be associated with pairing or bonding a user device 302 associated with a first-time user to a shared device 304 (e.g., vehicle). Example framework 300 may depict a general process or method of pairing a first-time user's device (e.g., user device 302) to a shared device 304, either or both of which may leverage or be communicatively coupled to a remote computing resource 306. In examples, shared device 304 may correspond to vehicle 102 and/or vehicle 208. In examples, remote computing resource 406 may correspond to remote computing resource 108 and/or remote computing resource 210.

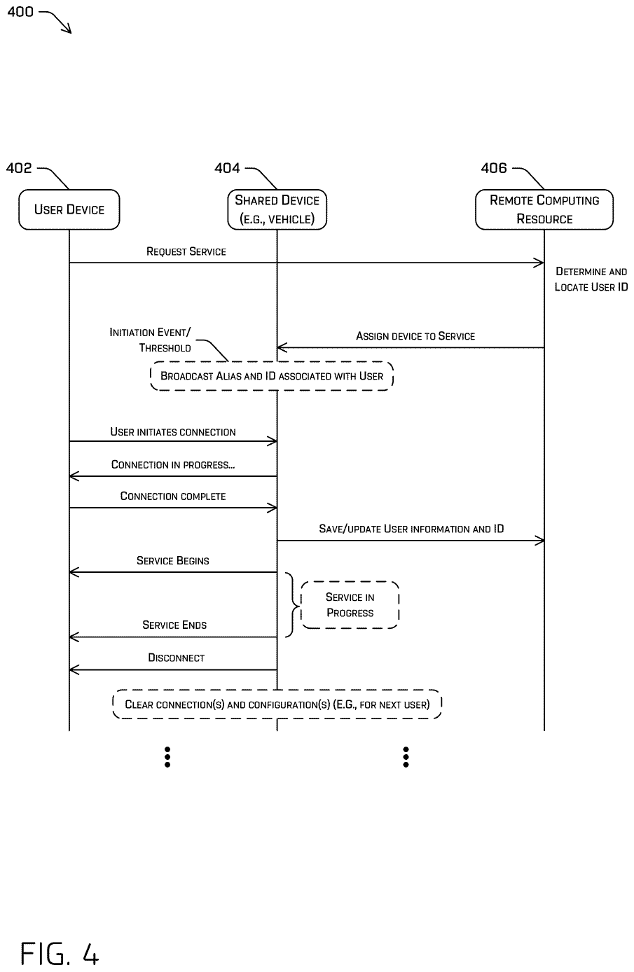

In other examples, where the techniques of this disclosure are applied to non-vehicle use cases or to architectures that do not involve vehicle(s), shared device 304 may comprise any device or computing resource capable of communicatively coupling to a user device 302. For example, as noted above, shared device 304 may comprise personal device(s) (e.g., smartwatches, smart glasses), automotive or transportation devices (e.g., infotainment systems), home devices (e.g., Bluetooth speakers, smart TVs, smart locks or lights, thermostats, home assistants), health and fitness devices (e.g., heart rate or blood sugar monitors), and so on. For purposes of clarity and not limitation, many of the examples described with regard to FIGS. 3 and 4 involve vehicles. However, one of ordinary skill in the art will understand and appreciate the value of the techniques discussed herein and the broad applicability to technologies and device(s) outside the realm of vehicle(s).

Example framework 300 is meant to be illustrative rather than limiting, and the order, structure, and/or sequence of events or steps of example framework 300 may be altered or modified. For example, generating/assigning a user profile to the user device 302 may occur immediately succeeding the receipt of the service request and the determination that the user device 302 is not associated with a user profile. As another example, the user profile may be generated/assigned nearer the conclusion of example framework 300, immediately preceding clearing the communication connection and configuration(s). Other formats, sequences, and combinations are contemplated herein, and one or ordinary skill in the art will appreciate that many of the steps and techniques depicted by example framework 300 may be modified accordingly.

As depicted, a user (e.g., user 104) may request service (e.g., a request for transportation to a destination). The service request may be transmitted to a remote computing resource 306. Remote computing resource 306 may be configured to operate or monitor a fleet of vehicle(s) operating in an environment. Remote computing resource 306 may be associated with a service or application (e.g., ride share application, rental car service). Remote computing resource 306 may, upon receipt of the transmitted service request, look up a user associated with the service request. Remote computing resource 306 may store or have access to a data store that houses participant/member data of the application or service. Each participant/member data entry may correspond to a user profile. In the depicted example framework 300, the user device 302 may be associated with a first-time user, meaning remote computing resource 306 may not be able to locate or determine a user profile associated with the user requesting service (because, e.g., the first-time user does not have a user profile).

Notwithstanding the existence of a user profile, remote computing resource 306 may assign a device to the service request (e.g., may determine a preferred or optimal vehicle to transport the user to their destination).

Upon occurrence of an initiation event and/or satisfaction of an initiation threshold, the shared device 304 may broadcast an alias in association with an identifier associated with the user device (e.g., User A's Vehicle). For example, the shared device 304 may broadcast a public alias associated with the identifier such that a user of the user device 302 may easily identify and select the shared device 304 among a list of device(s) available for wireless connection.

In some examples, remote computing resource 306 may assign a user device profile. For example, remote computing resource 306 may generate a new entry in the remote store of participants/members and may associate the user device's identifier with the new entry.

In some examples, the user may initiate, via their user device 302, a pairing or bonding sequence with the shared device 304 assigned to the service request. The shared device 304 and the user device 302 may implement one or more “handshake” procedures discussed herein or otherwise contemplated to establish or configure a valid pair/bond between the two devices.

In examples, after establishing/configuring a valid pair/bond, shared device 304 may transmit data (e.g., address data, identifier) associated with the user device 302 to remote computing resource 306. Remote computing resource 306 may update the user device profile accordingly. Although depicted as succeeding the completed pairing and as preceding the service beginning, transmitting the user data (and saving and updating the user device profile accordingly) may be implemented later in example framework 300 and/or may be implemented multiple instances throughout example framework 300.

The duration from the time the service begins (e.g., the user is picked up at a starting location) to the time the service ends (e.g., the user is dropped off at their destination) may be referred to as the service duration. While the service is in progress (throughout the service duration), the configuration data may be presented to the user and applied to shared device 304. Throughout the service duration, the user associated with the user device 302 may manipulate, alter, or otherwise control configuration data, as discussed above.

At the conclusion of the service duration, the shared device 304 may disconnect from the user device 302. Disconnecting the wireless connection between the shared device 304 and the user device 302 may not comprise unbonding or unpairing the user device 302.

As depicted by example framework 300, after disconnection of the shared device from the user device 302, all associated connections and configurations may be terminated and cleared. Disconnecting the shared device and clearing the configurations may restore the shared device 304 to a default state. For example, restoring the shared device 304 to its default settings (e.g., or settings applied before user device 302 transmitted the service request) may ensure an efficient and reliable wireless connection between the shared device 304 and subsequent user device(s).

FIG. 4 illustrates an example framework 400 configured to implement one or more of the techniques discussed herein. For example, example framework 400 may be associated with connecting a user device 402 associated with a repeat user to a shared device 404 (e.g., a vehicle). Example framework 400 may depict a process or method of connecting a repeat-user's device (e.g., user device 402) to a shared device 404, either or both of which may leverage or be communicatively coupled to a remote computing resource 406. In examples, shared device 404 may correspond to vehicle 102 and/or vehicle 208. In examples, remote computing resource 406 may correspond to remote computing resource 108 and/or remote computing resource 210.

In other examples, as discussed above with regard to FIG. 3, where the techniques of this disclosure are applied to non-vehicle use cases or to architectures that do not involve vehicle(s), shared device 404 may comprise any device or computing resource capable of communicatively coupling to user device 402.

Example framework 400 is meant to be illustrative rather than limiting, and the order, structure, and/or sequence of events or steps of example framework 400 may be altered or modified. Other formats, sequences, and combinations are contemplated herein, and one of ordinary skill in the art will understand and appreciate that many of the steps and techniques depicted by example framework 400 may be modified accordingly.

As depicted, a user (e.g., user 104) may request service (e.g., a request for transportation to a destination). The service request may be transmitted to a remote computing resource 406.

Remote computing resource 406 may be configured to operate or monitor a fleet of vehicle(s) operating in an environment. Remote computing resource 406 may be associated with a service or application (e.g., ride share application, rental car service). Remote computing resource 406 may, upon receipt of the transmitted service request, look up a user associated with the service request. Remote computing resource 406 may store or have access to a data store that houses participant/member data of the application or service. Each participant/member data entry may correspond to a user profile.

In the depicted example framework 400, user device 402 may be associated with a repeat user, meaning remote computing resource 406 may locate a user profile associated with user device 402 (e.g., via identifier 112). A user profile associated with the user device 402 may comprise configuration data (e.g., configuration data 114 and/or configuration data 222).

Remote computing resource 406 may assign a shared device 404 to the service request. For example, remote computing resource 406 may determine a preferred or optimal vehicle to transport the user to their destination and may transmit route data (e.g., route data 106, route data 204) to the vehicle accordingly.

Upon occurrence of an initiation event and/or satisfaction of an initiation threshold, shared device 404 may broadcast an alias in association with an identifier associated with the user device (e.g., User A's Vehicle). For example, shared device 404 may broadcast a public alias associated with the identifier such that a user of the user device 402 may easily identify and select the shared device 404 among a list of device(s) available for wireless connection.

In some examples, the user may initiate, via their user device 402, a pairing or bonding sequence with the shared device 404 assigned to the service request. The shared device 404 and the user device 402 may implement one or more “handshake” procedures discussed herein or otherwise contemplated to establish or configure a valid pair/bond between the two devices.

In examples, after establishing/configuring a valid pair/bond, shared device 404 may transmit data (e.g., address data, identifier) associated with the user device 402 to remote computing resource 406. Remote computing resource 406 may update the user device profile accordingly. Although depicted as succeeding the completed pairing and as preceding the service beginning, transmitting the user data (and saving and updating the user device profile accordingly) may be implemented later in example framework 400 and/or may be implemented multiple instances throughout example framework 400.

The duration from the time the service begins (e.g., the user is picked up at a starting location) to the time the service ends (e.g., the user is dropped off at their destination) may be referred to as the service duration. While the service is in progress (throughout the service duration), the configuration data may be presented to the user and applied to shared device 404. Throughout the service duration, the user associated with the user device 402 may manipulate, alter, or otherwise control configuration data, as discussed above.

At the conclusion of the service duration, the shared device 404 may disconnect from the user device 402. Disconnecting the wireless connection between the shared device 404 and the user device 402 may not comprise unbonding or unpairing the user device 402.

As depicted by example framework 400, after disconnection of the shared device from the user device 402, all associated connections and configurations may be terminated and cleared. For example, restoring the shared device 404 to its default settings (e.g., or settings applied before user device 402 transmitted the service request) may ensure an efficient and reliable wireless connection between the shared device 404 and subsequent user device(s).

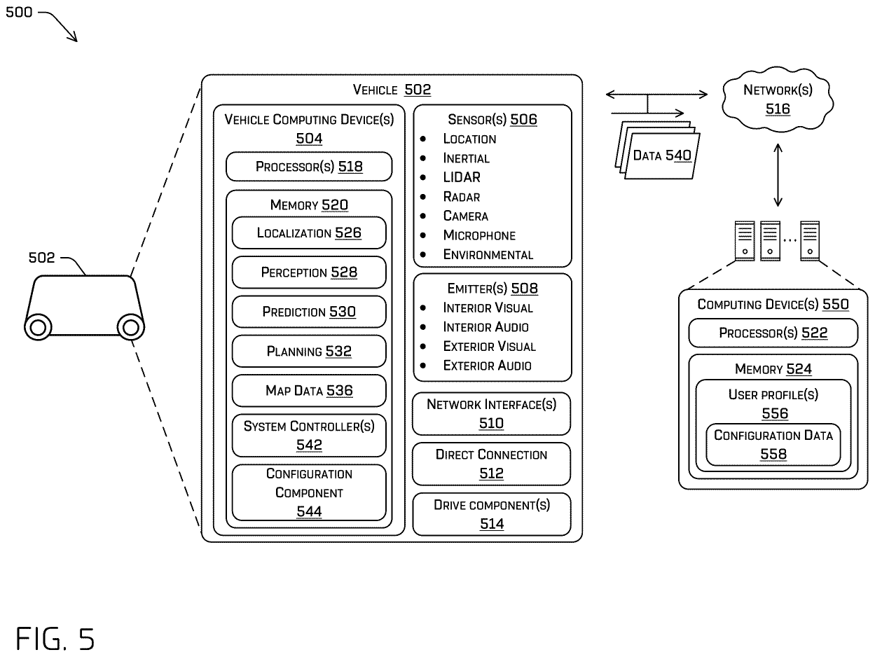

FIG. 5 illustrates a block diagram of an example system 500 for implementing the techniques discussed herein. The vehicle 502 (which may correspond to vehicle 102, vehicle 208, shared device 304, and/or shared device 404) may include one or more vehicle computing device(s) 504, one or more sensor system(s) 506, one or more emitters 508, one or more network interface(s) 510, at least one direct connection (e.g., one or more of a direct connection 512), and one or more drive component(s) 514.

Vehicle computing device(s) 504 may include one or more processor(s) 518 and memory 520 communicatively coupled with the one or more processor(s) 518. In examples, memory 520 (and/or memory 524) may store processor-executable instructions that, when executed, cause the one or more processor(s) 518 (and/or processor(s) 522) to implement one or more of the techniques, processes, and/or methods herein. In the example system 500, the vehicle 502 is an autonomous vehicle; however, the vehicle 502 could be any other type of vehicle or mobile robot. In the example system 500, the memory 520 of the vehicle computing device(s) 504 stores a localization component 526, a perception component 528, a prediction component 530, a planning component 532, map data 536, one or more system controller(s) 542, and configuration component 544.

Though depicted in FIG. 5 as residing in memory 520 for illustrative purposes, it is contemplated that the localization component 526, the perception component 528, the map data 536, the one or more system controller(s) 542, the prediction component 530, the configuration component 544, and/or the planning component 532 may additionally, or alternatively, be accessible to the vehicle 502 (e.g., stored remotely, e.g., in remote computing resource 108 and/or remote computing resource 210). Although depicted in FIG. 5 as being a component of vehicle 502, configuration component 544 may be a component of computing device(s) 550. configuration component 544 may be at least in part responsible for establishing wireless connection(s) with user device(s) and/or with applying or presenting configuration data in the vehicle 502.

In at least one example, the localization component 526 may include functionality to receive data from the sensor system(s) 506 to determine a position and/or orientation of the vehicle 502 (e.g., one or more of an x-, y-, z-position, roll, pitch, or yaw). For example, the localization component 526 may include and/or request/receive a map of an environment and may continuously determine a location and/or orientation of the autonomous vehicle within the map. In some instances, the localization component 526 may utilize SLAM (simultaneous localization and mapping), CLAMS (calibration, localization and mapping, simultaneously), relative SLAM, bundle adjustment, non-linear least squares optimization, or the like to receive image data, lidar data, radar data, IMU data, GPS data, wheel encoder data, and the like to accurately determine a location of the autonomous vehicle. In some instances, the localization component 526 may provide data to various components of the vehicle 502 to determine an initial position of an autonomous vehicle for generating a trajectory and/or for generating or receiving map data, as discussed herein.

In some instances, the perception component 528 may include functionality to perform object detection, segmentation, and/or classification. In some examples, the perception component 528 may provide processed sensor data that indicates a presence of an entity that is proximate to the vehicle 502 and/or a classification of the entity as an entity type (e.g., car, pedestrian, cyclist, animal, building, tree, road surface, curb, sidewalk, unknown, etc.). In additional or alternative examples, the perception component 528 may provide processed sensor data that indicates one or more characteristics associated with a detected entity (e.g., a tracked object) and/or the environment in which the entity is positioned. In some examples, characteristics associated with an entity may include, but are not limited to, an x-position (global and/or local position), a y-position (global and/or local position), a z-position (global and/or local position), an orientation (e.g., a roll, pitch, yaw), an entity type (e.g., a classification), a velocity of the entity, an acceleration of the entity, an extent of the entity (size), etc. Characteristics associated with the environment may include, but are not limited to, a presence of another entity in the environment (e.g., an agent), a state of another entity (e.g., an object or feature) in the environment, a time of day, a day of a week, a season, a weather condition, an indication of darkness/light, etc.

The memory 520 may further include map data 536 that may be used by the vehicle 502 to navigate and/or traverse within the environment. For the purpose of this discussion, map data may comprise any number of data structures modeled in two dimensions, three dimensions, or N-dimensions that are capable of providing information about an environment, such as, but not limited to, topologies (such as intersections), streets, mountain ranges, roads, terrain, and the environment in general. In some instances, a map may include, but is not limited to: texture information (e.g., color information (e.g., RGB color information, Lab color information, HSV/HSL color information), and the like), intensity information (e.g., LIDAR information, RADAR information, and the like); spatial information (e.g., image data projected onto a mesh, individual “surfels” (e.g., polygons associated with individual color and/or intensity)), reflectivity information (e.g., specularity information, retroreflectivity information, BRDF information, BSSRDF information, and the like).

In one example, map data 536 may include a three-dimensional mesh of the environment. In some instances, map data 536 may be stored in a tiled format, such that individual tiles of the map represent a discrete portion of an environment, and may be loaded into working memory as needed, as discussed herein. In at least one example, the map data 536 may include at least one map (e.g., images and/or a mesh). In some examples, the vehicle 502 may be controlled based at least in part on the map data 536. In some examples, map data 536 may be stored on a remote computing device(s) (such as the computing device(s) 550) accessible via network(s) 516. In some examples, multiple maps may be stored based on, for example, a characteristic (e.g., type of entity, time of day, day of week, season of the year, etc.). Storing multiple maps may have similar memory requirements but increase the speed at which data in a map may be accessed.

In at least one example, the vehicle 502 may include one or more system controller(s) 542, which may be configured to control steering, propulsion, braking, safety, emitters, communication, and other systems of the vehicle 502. These system controller(s) 542 may communicate with and/or control corresponding systems of the drive component(s) 514 and/or other components of the vehicle 502.

In some examples, the prediction component 530 may include functionality to generate one or more probability maps representing prediction probabilities of possible locations of one or more objects or agents in an environment. For example, the prediction component 530 can generate one or more probability maps for vehicles, pedestrians, animals, and the like within a threshold distance from the vehicle 502. In some instances, the prediction component 530 can measure a track or trajectory of an object/agent and generate a discretized prediction probability map, a heat map, a probability distribution, a discretized probability distribution, and/or a trajectory for the object/agent based on observed and predicted behavior. In some instances, the one or more probability maps can represent an intent of the one or more objects/agents in the environment.

In some examples, the planning component 532 may include functionality to determine a path for the vehicle 502 to follow to traverse through an environment. For example, the planning component 532 can determine various routes and paths and various levels of detail. In some instances, the planning component 532 can determine a route to travel from a first location (e.g., a current location) to a second location (e.g., a target location). For the purpose of this discussion, a route can be a sequence of waypoints for traveling between two locations. As non-limiting examples, waypoints include streets, intersections, global positioning system (GPS) coordinates, etc. Further, the planning component 532 can generate an instruction for guiding the autonomous vehicle along at least a portion of the route from the first location to the second location. In at least one example, the planning component 532 can determine how to guide the autonomous vehicle from a first waypoint in the sequence of waypoints to a second waypoint in the sequence of waypoints. In some examples, the instruction can be a path, or a portion of a path. In some examples, multiple paths can be substantially simultaneously generated (i.e., within technical tolerances) in accordance with a receding horizon technique. A single path of the multiple paths in a receding data horizon having the highest confidence level may be chosen to operate the vehicle.

In other examples, the planning component 532 can alternatively, or additionally, use data from the perception component 528 and/or the prediction component 530 to determine a path for the vehicle 502 to follow to traverse through an environment. For example, the planning component 532 can receive data from the perception component 528 and/or the prediction component 530 regarding objects/agents/features associated with an environment. Using this data, the planning component 532 can determine a route to travel from a first location (e.g., a current location) to a second location (e.g., a target or destination location) to avoid objects in an environment. In at least some examples, such a planning component 532 may determine there is no such collision free path and, in turn, provide a path which brings vehicle 502 to a safe stop avoiding all collisions and/or otherwise mitigating damage.

In some examples, example system 500 may additionally or alternatively comprise an error monitoring component. The error monitoring component may be responsible for or tasked with monitoring the systems and components of the vehicle 502 (e.g., sensor system(s) 506, drive component(s) 514, etc.) and to log, report, or otherwise flag errors experienced by the vehicle 502 and/or its systems and components. The error monitoring component may determine if and when errors (e.g., vehicle errors states) occur, and/or may classify errors based on their severity/importance to the overall functionality of the vehicle 502 system.

In some instances, aspects of some or all of the components discussed herein may include any models, algorithms, and/or machine learning algorithms. For example, in some instances, the components in the memory 520 (and the memory 524, discussed below) may be implemented as a neural network. For example, the remote computing device(s) 550 may leverage or employ one or more neural networks in carrying out the techniques described herein.

As described above, an exemplary neural network is an algorithm which passes input data through a series of connected layers to produce an output. Each layer in a neural network may also comprise another neural network or may comprise any number of layers (whether convolutional or not). As may be understood in the context of this disclosure, a neural network may utilize machine learning, which may refer to a broad class of such algorithms in which an output is generated based on learned parameters.

Although discussed in the context of neural networks, any type of machine learning may be used consistent with this disclosure. For example, machine learning algorithms and/or techniques discussed below with regard to FIG. 5 may be leveraged individually or in combination to accomplish the techniques herein.

In at least one example, the sensor system(s) 506 may include lidar sensors, radar sensors, ultrasonic transducers, sonar sensors, location sensors (e.g., GPS, compass, etc.), inertial sensors (e.g., inertial measurement units (IMUs), accelerometers, magnetometers, gyroscopes, etc.), cameras (e.g., RGB, IR, intensity, depth, etc.), time of flight sensors, audio sensors, wheel encoders, environment sensors (e.g., temperature sensors, humidity sensors, light sensors, pressure sensors, etc.), etc. The sensor system(s) 506 may include multiple instances of each of these or other types of sensors. For instance, the lidar sensors may include individual lidar sensors located at the corners, front, back, sides, and/or top of the vehicle 502. As another example, the camera sensors may include multiple cameras disposed at various locations about the exterior and/or interior of the vehicle 502. The sensor system(s) 506 may provide input to the vehicle computing device(s) 550. Additionally, or alternatively, the sensor system(s) 506 may send sensor data, via the one or more network(s) 516, to the one or more computing device(s) at a particular frequency, after a lapse of a predetermined period of time, in near real-time, etc. In at least some examples, the sensor system(s) 506 may be responsible for determining sensor data as discussed above.

The vehicle 502 may also include one or more emitters 508 for emitting light and/or sound, as described above. The emitters 508 in this example include interior audio and visual emitters to communicate with passengers of the vehicle 502. By way of example and not limitation, interior emitters may include speakers, lights, signs, display screens, touch screens, haptic emitters (e.g., vibration and/or force feedback), mechanical actuators (e.g., seatbelt tensioners, seat positioners, headrest positioners, etc.), and the like. The emitters 508 in this example also include exterior emitters. By way of example and not limitation, the exterior emitters in this example include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which comprising acoustic beam steering technology.

The vehicle 502 may also include one or more network interface(s) 510 that enable communication between the vehicle 502 and one or more other local or remote computing device(s). For instance, the network interface(s) 510 may facilitate communication with other local computing device(s) on the vehicle 502 and/or the drive component(s) 514. Also, the network interface(s) 510 may allow the vehicle 502 to communicate with other nearby computing device(s) (e.g., other nearby vehicles, traffic signals, etc.). The network interface(s) 510 may also enable the vehicle 502 to communicate with remote operations or other remote services.

The network interface(s) 510 may include physical and/or logical interfaces for connecting the vehicle computing device(s) 550 to another computing device (e.g., a vehicle 502) or a network, such as network(s) 516. For example, the network interface(s) 510 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.) or any suitable wired or wireless communications protocol that enables the respective computing device to interface with the other computing device(s).

The network interface(s) 510 may, for example, be at least partially responsible for communicatively coupling with user device(s) according to the techniques of this disclosure. In some examples, network interface(s) 510 may interface with user device(s) individually or in combination with other components or systems (e.g., configuration component 544) associated with vehicle 502. Additionally or alternatively, network interface(s) 510 may be at least partially responsible for broadcasting or transmitting network connectivity to user device(s) in the vehicle, as discussed in more detail above.

In at least one example, the vehicle 502 may include one or more drive component(s) 514. In some examples, the vehicle 502 may have a single drive component. In at least one example, if the vehicle 502 has multiple drive component(s) 514, individual drive components may be positioned on opposite ends of the vehicle 502 (e.g., the front and the rear, etc.). In at least one example, the drive component(s) 514 may include one or more sensor systems to detect conditions of the drive component(s) 514 and/or the surroundings of the vehicle 502 (e.g., monitored by an error monitoring component). By way of example and not limitation, the sensor system(s) may include one or more wheel encoders (e.g., rotary encoders) to sense rotation of the wheels of the drive systems, inertial sensors (e.g., inertial measurement units, accelerometers, gyroscopes, magnetometers, etc.) to measure orientation and acceleration of the drive system, cameras or other image sensors, ultrasonic sensors to acoustically detect objects in the surroundings of the drive system, lidar sensors, radar sensors, etc. Some sensors, such as the wheel encoders may be unique to the drive component(s) 514. In some cases, the sensor system(s) on the drive component(s) 514 may overlap or supplement corresponding systems of the vehicle 502 (e.g., sensor system(s) 506).

The drive component(s) 514 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive component(s) 514 may include a drive system controller which may receive and preprocess data from the sensor system(s) and to control operation of the various vehicle systems. In some examples, the drive system controller may include one or more processors and memory communicatively coupled with the one or more processors. The memory may store one or more components to perform various functionalities of the drive component(s) 514. Furthermore, the drive component(s) 514 also include one or more communication connection(s) that enable communication by the respective drive system with one or more other local or remote computing device(s).

In at least one example, the direct connection 512 may provide a physical interface to couple the one or more drive component(s) 514 with the body of the vehicle 502. For example, the direct connection 512 may allow the transfer of energy, fluids, air, data, etc. between the drive component(s) 514 and the vehicle. In some instances, the direct connection 512 may further releasably secure the drive component(s) 514 to the body of the vehicle 502.

In some examples, the vehicle 502 may send sensor data and/or log data (e.g., data 540), which may comprise sensor data and/or log data associated with a vehicle operating in an environment to one or more computing device(s) 550 via the network(s) 516. In some examples, the vehicle 502 may send raw sensor data and/or log data (e.g., data 540) to the computing device(s) 550. In other examples, the vehicle 502 may send processed sensor data and/or log data and/or representations of sensor data and/or log data to the computing device(s) 550. In some examples, the vehicle 502 may send sensor data and/or log data to the computing device(s) 550 at a particular frequency, after a lapse of a predetermined period of time, in near real-time, etc. In some cases, the vehicle 502 may send sensor data (raw or processed) and/or log data to the computing device(s) 550 as one or more log files.

In some examples, memory 524 may additionally or alternatively comprise map data. Map data may be a storage device or service remotely accessible to one or more vehicles, as discussed above. Additionally or alternatively, a remote operations system (which may comprise computing device(s) 550) may be communicatively coupled to or have access to map data.

In some examples, the vehicle 502 may comprise a configuration component 544. The configuration component 544 may comprise the techniques, processes, and/or procedures to communicatively couple the vehicle 502 with one or more user device(s). Configuration component 544 may, in some examples, communicate or interface with other components of the vehicle 502 (e.g., emitter(s) 508, sensor system(s) 506) to present configuration data in the vehicle. For example, the configuration component 544 may, upon determination of configuration data (e.g., receipt from a remote computing resource or retrieved from a remote or local data store), apply or implement the configuration data such that the configuration data is presented in the vehicle for the duration of the transport or service (or, e.g., before the transport or service beings, as discussed above).

The processor(s) 518 of the vehicle 502 and the processor(s) 522 of the computing device(s) 550 may be any suitable processor capable of executing instructions to process data and perform operations as described herein. By way of example and not limitation, the processor(s) 518 and 522 may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

Memory 520 and 524 are examples of non-transitory computer-readable media. The memory 520 and 524 may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, the memory 520 and 524 may include at least a working memory and a storage memory. For example, the working memory may be a high-speed memory of limited capacity (e.g., cache memory) that is used for storing data to be operated on by the processor(s) 518 and 522. In some instances, the memory 520 and 524 may include a storage memory that may be a lower-speed memory of relatively large capacity that is used for long-term storage of data. In some cases, the processor(s) 518 and 522 may not operate directly on data that is stored in the storage memory, and data may need to be loaded into a working memory for performing operations based on the data, as discussed herein.

In some examples, computing device(s) 550 may comprise an inventory or accessible data store of user profile(s) 556. User profile(s) 556 may store configuration data 558 (which may correspond to configuration data 114 and/or configuration data 222) associated with user(s) and/or their user device(s). User profile(s) 556 may be remotely accessible to vehicle 502, and/or computing device(s) 550 may be configured to transmit configuration data 558 to vehicle 502, where the vehicle 502 may then apply or implement configuration data 558 (e.g., via configuration component 544 and present it in the vehicle 502.

It should be noted that while FIG. 5 is illustrated as a distributed system, in alternative examples, components of the vehicle 502 may be associated with the computing device(s) 550 and/or components of the computing device(s) 550 may be associated with the vehicle 502. That is, the vehicle 502 may perform one or more of the functions associated with the computing device(s) 550, and vice versa.

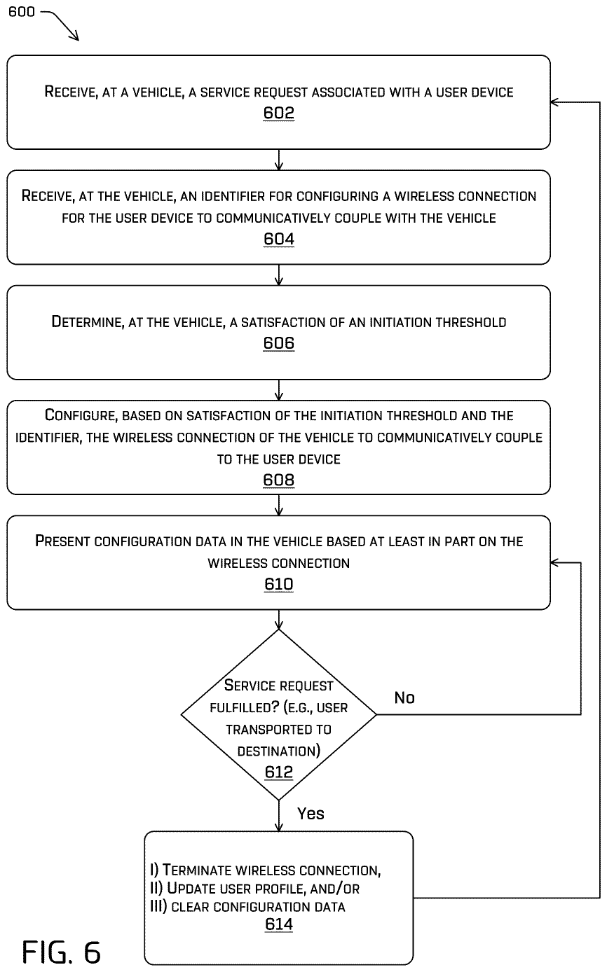

FIG. 6 illustrates an example process 600 in accordance with one or more of the techniques discussed herein. At operation 602, example process 600 may comprise receiving (e.g., at a vehicle) a service request associated with a user device. As discussed above, the user may have transmitted a request for transportation, and/or the user may have used their associated user device to scan a code displayed by the vehicle or otherwise interact with a vehicle. In either scenario, in addition to others contemplated herein, the vehicle may receive the service request. In another example, a user may transmit a service request for a different user who may be associated with their own user device (e.g., a user may hail a vehicle on behalf of another person, and that other person may be associated with their own device).

At operation 604, example process 600 may comprise receiving (e.g., at the vehicle), an identifier for configuring a wireless connection for the user device to communicatively couple with the vehicle. For example, the vehicle may receive the identifier associated with the user device, which may comprise or be associated with a shared secret key, a user profile, and/or configuration data. In some examples, the wireless connection may be associated with or based at least in part on a Bluetooth protocol.

At operation 606, example process 600 may comprise determining (e.g., at the vehicle or at a remote computing resource and then transmitted to the vehicle), a satisfaction of an initiation threshold. In some examples, discussed above, the initiation threshold may be a threshold distance or proximity, signal strength, and so on.

At operation 608, example process 600 may comprise configuring, based at least in part on the satisfaction of the initiation threshold and the identifier, the wireless connection of the vehicle to communicatively couple to the user device. For example, operation 608 may comprise exchanging key(s) associated with the user device and the vehicle, and/or determining a shared private key (e.g., if the vehicle and the user device have not paired previously). One or ordinary skill in the art will understand and appreciate the myriad techniques, processes, and/or methods that may configure a wireless connection between device(s) e.g., between a vehicle and a user device).

At operation 610, example process 600 may comprise presenting configuration data in the vehicle (e.g., to the user and/or their user device) based at least in part on configuring the wireless connection. As discussed in more detail above, presenting configuration data in the vehicle may allow a user to control or modify certain aspects of various vehicle components (e.g., audio configuration data, lighting or ambiance settings, seat heating/cooling preferences, and so on).

At operation 612, example process 600 may comprise determining whether the service request has been fulfilled. For example, in the scenario where the service request is associated with transporting a user to a destination, operation 612 may determine whether the user has been delivered or dropped off at their destination. If the service request has not been fulfilled, example process 600 may follow the “No” block and continue presenting configuration data (e.g., an audio configuration) in the vehicle. Operation 612 may occur at given time intervals (e.g., every 1 minute, 10 minutes), at defined event occurrences or threshold satisfactions (e.g., when the vehicle comes to a stop at the destination, when the vehicle is within a threshold proximity from the destination, when the user device is outside of a threshold distance from the vehicle, and so on), or any combination thereof.

At operation 612, if the service request has been fulfilled, example process 600 may follow the “Yes” block and continue to operation 614. At operation 614, example process 600 may comprise reconfiguring the vehicle for use by another user. More specifically, at operation 614, example process 600 may comprise terminating the wireless connection, updating a user profile associated with the user (e.g., to reflect modifications to configuration data), and/or clearing configuration data. In the latter example, the vehicle may clear all configuration data and may return to a default state. Doing so may configure the vehicle to receive an additional service request and thereby start over at operation 602. For example, the vehicle may return all lighting, audio configuration data, seat position, and/or HVAC preferences and settings to a default state such that the vehicle is prepared to implement example process 600 for the same (e.g., the same user on a different service request) or a different user (e.g., a different user requests transportation).

In at least some examples, as discussed in more detail above, a user profile associated with the user may be transmitted to a remote data store. The remote data store may be configured to store user profile(s) in association with associated identifier(s). In examples, example process 600 may comprise transmitting, to a remote data store accessible to a fleet of vehicles operating in an environment associated with the autonomous vehicle, a user profile associated with the user. The user profile may be retrievable to or accessible by individual vehicles in the fleet of vehicles (e.g., individual vehicles may access the remote data store to determine configuration settings and preferences indicated by the user). For example, when the user requests transportation, a second vehicle (the same or a different vehicle in the fleet) may retrieve or access the user profile (e.g., to implement/apply configuration data in the second vehicle prior to picking up the user and/or prior to configuring the wireless connection between the user's device and the second vehicle). In some examples, the remote data store configured to store user profile(s) may comprise a data center or server remotely accessible to vehicle(s) (e.g., via one or more network(s)). In other examples, the remote data store from which the second vehicle may retrieve or access the user profile (or indicator associated with the user's user device) may be the first vehicle (e.g., the second vehicle may transmit a request and/or receive data from the first vehicle). In another example, the remote data store from which the second vehicle may retrieve or access the user profile or indicator may comprise the user's user device. In such an example, the second vehicle may transmit a request and/or receive data from the user device associated with the user such that the second vehicle may determine configuration data.

As a more concrete nonlimiting example, a first vehicle may satisfy a user's first request for transportation (e.g., the user was dropped off at their destination). During or after the first user's transportation, the vehicle or user device may transmit, to a remote data store, a user profile associated with the user, along with an indication of preferences/settings. The remote data store may comprise a database or server, the user device itself, and/or the first vehicle, and may be remotely accessible to other vehicles in a fleet. Thereafter, a second vehicle (e.g., the same or different than the first vehicle) may be assigned to a user's subsequent request for transportation. The second vehicle may retrieve, from the remote data store, the user profile associated with the user. Doing so may configure the second vehicle to implement or apply the user's preferences prior to the user's ingress into the second vehicle and/or prior to configuring the wireless connection between the user device and the second vehicle.

The operations of example process 600 are depicted for purposes of clarity and not limitation. In some examples, the operations may be manipulated, reordered, and/or may comprise additional, alternative, and/or fewer steps than those depicted. One of ordinary skill in the art will understand and appreciate the various formats and processes that may facilitate the techniques of this disclosure.

### EXAMPLE CLAUSES

A: A system comprising: one or more processors; and one or more non-transitory computer-readable media storing processor-executable instructions that, when executed by the one or more processors, cause the one or more processors to perform operations comprising: receiving, at an autonomous vehicle, route data associated with transporting a user associated with a user device to a destination; receiving, at the autonomous vehicle, an identifier for configuring a short-range communication connection to the user device; determining, at the autonomous vehicle, an occurrence of an initiation event associated with the user device; configuring, based on the occurrence of the initiation event and the identifier, the short-range communication connection of the autonomous vehicle to the user device; and presenting, in the autonomous vehicle, an audio configuration based at least in part on the short-range communication connection.

B: The system of paragraph A, the operations further comprising generating, based at least in part on the identifier, a user profile associated with the user, the user profile configured to store configuration settings and preferences indicated by the user.

C: The system of paragraph B, the operations further comprising: transmitting, to a remote data store accessible to a fleet of vehicles operating in an environment associated with the autonomous vehicle, the user profile, and wherein individual vehicles in the fleet of vehicles may access the remote data store to determine the configuration settings and preferences indicated by the user.

D: The system of any of paragraphs A-C, the operations further comprising: determining, based at least in part on the audio configuration presented in the autonomous vehicle while transporting the user to the destination, an audio data preference associated with the user; and updating, based at least in part on the identifier and the audio data preference, a user profile associated with the user device.

E: The system of any of paragraphs A-D, the autonomous vehicle being a first autonomous vehicle, the operations further comprising: receiving, at a second autonomous vehicle, a second route data associated with transporting the user associated with the user device to a second destination; receiving, at the second autonomous vehicle, the identifier; and presenting, in the second autonomous vehicle, at least a portion of the audio configuration prior to configuring a second short-range communication connection of the second autonomous vehicle to the user device.

F: The system any of paragraphs A-E, the operations further comprising: receiving, from the user device, an indication to initiate a handoff procedure; and facilitating, based at least in part on the indication, the handoff procedure to transfer the short-range communication connection to a second user device in the autonomous vehicle.

G: The techniques of any of paragraphs A-F, further comprising: a method comprising: receiving, at a vehicle, a service request associated with a user device; receiving, at the vehicle, an identifier for configuring a wireless connection for the user device to communicatively couple with the vehicle; determining, at the vehicle, a satisfaction of an initiation threshold; configuring, based on the satisfaction of the initiation threshold and the identifier, the wireless connection of the vehicle to communicatively couple to the user device; and presenting configuration data in the vehicle based at least in part on the wireless connection.

H: The techniques of any of paragraphs A-G, further comprising: terminating, based at least in part on the service request being fulfilled, the wireless connection between the user device and the vehicle; and clearing, based on the wireless connection being terminated, the configuration data presented in the vehicle to restore the vehicle to a default state.

I: The techniques of any of paragraphs A-H, wherein the user device is associated with a first key and a shared key, the vehicle is associated with a second key and the shared key, and wherein configuring the wireless connection is based at least in part on the user device and the vehicle exchanging the first key and the second key using the shared key.

J: The techniques of any of paragraphs A-I, wherein presenting the configuration data in the vehicle comprises: retrieving, based at least in part on the identifier and a remote data store, a user profile associated with the user device; and applying, in the vehicle, the configuration data associated with the user profile.

K: The techniques of any of paragraphs A-J, wherein configuring the wireless connection of the vehicle to communicatively couple to the user device is configured to allow a user to apply a modification to the configuration data as presented in the vehicle.

L: The techniques of any of paragraphs A-K, further comprising updating, based at least in part on the modification of the configuration data, a user profile associated with the identifier to reflect the modification.

M: The techniques of any of paragraphs A-L, further comprising generating, based at least in part on the identifier, a user profile associated with a user associated with the user device, the user profile configured to store the configuration data indicated by the user.

N: The techniques of any of paragraphs A-M, the vehicle being a first vehicle, the method further comprising: receiving, at a second vehicle different than the first vehicle, a second service request from the user device; receiving, at the second vehicle, the identifier; and presenting, in the second vehicle, at least a portion of the configuration data prior to configuring the wireless connection of the second vehicle to communicatively couple to the user device.

O: The techniques of any of paragraphs A-N, further comprising: one or more non-transitory computer-readable media storing processor-executable instructions that, when executed by one or more processors, cause the one or more processors to perform operations comprising: receiving, at a vehicle, a service request associated with a user device; receiving, at the vehicle, an identifier for configuring a wireless connection for the user device to communicatively couple with the vehicle; determining, at the vehicle, a satisfaction of an initiation threshold; configuring, based on the satisfaction of the initiation threshold and the identifier, the wireless connection of the vehicle to communicatively couple to the user device; and presenting configuration data in the vehicle based at least in part on the wireless connection.

P: The techniques of any of paragraphs A-O, the vehicle being a first vehicle, the operations further comprising: receiving, at a second vehicle different than the first vehicle, a second service request from the user device; receiving, at the second vehicle, the identifier; and presenting, in the second vehicle, at least a portion of the configuration data prior to configuring the wireless connection of the second vehicle to communicatively couple to the user device.

Q: The techniques of any of paragraphs A-P, wherein the user device is associated with a first key and a shared key, the vehicle is associated with a second key and the shared key, and wherein configuring the wireless connection is based at least in part on the user device and the vehicle exchanging the first key and the second key using the shared key.

R: The techniques of any of paragraphs A-Q, further comprising: terminating, based at least in part on the service request being fulfilled, the wireless connection between the user device and the vehicle; and clearing, based on the wireless connection being terminated, the configuration data presented in the vehicle to restore the vehicle to a default state

S: The techniques of any of paragraphs A-R, wherein configuring the wireless connection of the vehicle to communicatively couple to the user device is configured to allow a user to apply a modification to the configuration data as presented in the vehicle.

T: The techniques of any of paragraphs A-S, wherein presenting the configuration data in the vehicle comprises: retrieving, based at least in part on the identifier and a remote data store, a user profile associated with the user device; and applying, in the vehicle, the configuration data associated with the user profile.

While the example clauses described above are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
one or more non-transitory computer-readable media storing processor-executable instructions that, when executed by the one or more processors, cause the one or more processors to perform operations comprising:
receiving, at an autonomous vehicle, route data associated with transporting a user associated with a user device to a destination;
receiving, at the autonomous vehicle, an identifier for configuring a short-range communication connection to the user device;
determining, at the autonomous vehicle, an occurrence of an initiation event associated with the user device;
configuring, based on the occurrence of the initiation event and the identifier, the short-range communication connection of the autonomous vehicle to the user device; and
presenting, in the autonomous vehicle, an audio configuration based at least in part on the short-range communication connection.

2. The system of claim 1, the operations further comprising generating, based at least in part on the identifier, a user profile associated with the user, the user profile configured to store configuration settings and preferences indicated by the user.

3. The system of claim 2, the operations further comprising:
transmitting, to a remote data store accessible to a fleet of vehicles operating in an environment associated with the autonomous vehicle, the user profile, and wherein individual vehicles in the fleet of vehicles may access the remote data store to determine the configuration settings and preferences indicated by the user.

4. The system of claim 1, the operations further comprising:
determining, based at least in part on the audio configuration presented in the autonomous vehicle while transporting the user to the destination, an audio data preference associated with the user; and
updating, based at least in part on the identifier and the audio data preference, a user profile associated with the user device.

5. The system of claim 1, the autonomous vehicle being a first autonomous vehicle, the operations further comprising:
receiving, at a second autonomous vehicle, a second route data associated with transporting the user associated with the user device to a second destination;
receiving, at the second autonomous vehicle, the identifier; and
presenting, in the second autonomous vehicle, at least a portion of the audio configuration prior to configuring a second short-range communication connection of the second autonomous vehicle to the user device.

6. The system of claim 4, the operations further comprising:
receiving, from the user device, an indication to initiate a handoff procedure; and
facilitating, based at least in part on the indication, the handoff procedure to transfer the short-range communication connection to a second user device in the autonomous vehicle.

7. A method comprising:
receiving, at a vehicle, a service request associated with a user device;
receiving, at the vehicle, an identifier for configuring a wireless connection for the user device to communicatively couple with the vehicle;
determining, at the vehicle, a satisfaction of an initiation threshold;
configuring, based on the satisfaction of the initiation threshold and the identifier, the wireless connection of the vehicle to communicatively couple to the user device; and
presenting configuration data in the vehicle based at least in part on the wireless connection.

8. The method of claim 7, further comprising:
terminating, based at least in part on the service request being fulfilled, the wireless connection between the user device and the vehicle; and
clearing, based on the wireless connection being terminated, the configuration data presented in the vehicle to restore the vehicle to a default state.

9. The method of claim 7, wherein the user device is associated with a first key and a shared key, the vehicle is associated with a second key and the shared key, and wherein configuring the wireless connection is based at least in part on the user device and the vehicle exchanging the first key and the second key using the shared key.

10. The method of claim 7, wherein presenting the configuration data in the vehicle comprises:
retrieving, based at least in part on the identifier and a remote data store, a user profile associated with the user device; and
applying, in the vehicle, the configuration data associated with the user profile.

11. The method of claim 7, wherein configuring the wireless connection of the vehicle to communicatively couple to the user device is configured to allow a user to apply a modification to the configuration data as presented in the vehicle.

12. The method of claim 11, further comprising updating, based at least in part on the modification of the configuration data, a user profile associated with the identifier to reflect the modification.

13. The method of claim 7, further comprising generating, based at least in part on the identifier, a user profile associated with a user associated with the user device, the user profile configured to store the configuration data indicated by the user.

14. The method of claim 7, the vehicle being a first vehicle, the method further comprising:
receiving, at a second vehicle different than the first vehicle, a second service request from the user device;
receiving, at the second vehicle, the identifier; and
presenting, in the second vehicle, at least a portion of the configuration data prior to configuring the wireless connection of the second vehicle to communicatively couple to the user device.

15. One or more non-transitory computer-readable media storing processor-executable instructions that, when executed by one or more processors, cause the one or more processors to perform operations comprising:
receiving, at a vehicle, a service request associated with a user device;
receiving, at the vehicle, an identifier for configuring a wireless connection for the user device to communicatively couple with the vehicle;
determining, at the vehicle, a satisfaction of an initiation threshold;
configuring, based on the satisfaction of the initiation threshold and the identifier, the wireless connection of the vehicle to communicatively couple to the user device; and
presenting configuration data in the vehicle based at least in part on the wireless connection.

16. The one or more non-transitory computer-readable media of claim 15, the vehicle being a first vehicle, the operations further comprising:
receiving, at a second vehicle different than the first vehicle, a second service request from the user device;
receiving, at the second vehicle, the identifier; and
presenting, in the second vehicle, at least a portion of the configuration data prior to configuring the wireless connection of the second vehicle to communicatively couple to the user device.

17. The one or more non-transitory computer-readable media of claim 15, wherein the user device is associated with a first key and a shared key, the vehicle is associated with a second key and the shared key, and wherein configuring the wireless connection is based at least in part on the user device and the vehicle exchanging the first key and the second key using the shared key.

18. The one or more non-transitory computer-readable media of claim 15, further comprising:
terminating, based at least in part on the service request being fulfilled, the wireless connection between the user device and the vehicle; and
clearing, based on the wireless connection being terminated, the configuration data presented in the vehicle to restore the vehicle to a default state.

19. The one or more non-transitory computer-readable media of claim 15, wherein configuring the wireless connection of the vehicle to communicatively couple to the user device is configured to allow a user to apply a modification to the configuration data as presented in the vehicle.

20. The one or more non-transitory computer-readable media of claim 15, wherein presenting the configuration data in the vehicle comprises:
retrieving, based at least in part on the identifier and a remote data store, a user profile associated with the user device; and
applying, in the vehicle, the configuration data associated with the user profile.
